(19) United States
(12) Patent Application Publication
(10) Pub. No.: US 2024/0253691 A1
(43) Pub. Date: Aug. 1, 2024

(54) COMPONENT FOR VEHICLE INTERIOR

(71) Applicant: Shanghai Yanfeng Jinqiao Automotive Trim Systems Co. Ltd., Novi, MI (US)

(72) Inventors: Peter Thielhorn, Muelheim/Ruhr (DE); Holger Maul, Groß-Zimmern (DE); Heinz Gielen, Viersen (DE); Daniel Grosch, Pulheim (DE); Iris Wegner, Duesseldorf (DE); Lucas Steffens, Cologne (DE)

(21) Appl. No.: 18/632,567

(22) Filed: Apr. 11, 2024

Related U.S. Application Data
(63) Continuation of application No. PCT/US22/46625, filed on Oct. 13, 2022.
(60) Provisional application No. 63/262,513, filed on Oct. 14, 2021.

(51) Int. Cl. B62D 1/06; B62D 1/04

(52) U.S. Cl. CPC B62D 1/065; B62D 1/046

(57) ABSTRACT

A component for a vehicle interior may comprise a steering wheel comprising a composite structure assembled on a frame. The composite structure may comprise a cover and a carrier. The composite structure may comprise a set of segments comprising a decorative segment and/or a functional segment. The composite structure may comprise a rim comprising the set of segments. The functional segment may provide a user interface; operation of the user interface may comprise an output signal and/or an input signal; a control system may facilitate operation of a vehicle system through the user interface. The functional segment may comprise a transducer and/or sensor to detect input at/adjacent the cover. The functional segment may comprise a functional module; a functional layer; a heating element; a hands-off detector; and/or a positioning layer. The composite structure may comprise a modular design for efficient assembly and/or mass reduction.

### CROSS-REFERENCE TO RELATED APPLICATIONS

The present application is a continuation of PCT/International Patent Application No. PCT/US2022/46625 titled “COMPONENT FOR VEHICLE INTERIOR” filed Oct. 13, 2022, which claims the benefit of U.S. Provisional Patent Application No. 63/262,513 titled “VEHICLE INTERIOR COMPONENT” filed Oct. 14, 2021.

The present application claims priority to and incorporates by reference in full the following patent applications: (1) U.S. Provisional Patent Application No. 63/262,513 titled “VEHICLE INTERIOR COMPONENT” filed Oct. 14, 2021; (2) PCT/International Patent Application No. PCT/US2022/46625 titled “COMPONENT FOR VEHICLE INTERIOR” filed Oct. 13, 2022.

The present application is related to and incorporates by reference in full the following patent applications: (1) PCT/International Patent Application No. PCT/US2022/046626 titled “COMPONENT FOR VEHICLE INTERIOR” filed Oct. 13, 2022; (2) U.S. patent application Ser. No. ______ (Docket No. FIP 21074-UT-US-05) titled “COMPONENT FOR VEHICLE INTERIOR” filed April ______, 2024.

### FIELD

The present invention relates to a component for a vehicle interior.

The present invention also relates to a component such as a steering wheel for a vehicle interior.

### BACKGROUND

It is known to provide a component for a vehicle interior such as a steering wheel a base and a rim with a frame.

It would be advantageous to provide for a component for a vehicle interior such as a steering wheel that is configured with a rim comprising a composite structure.

It would be advantageous to provide for a component for a vehicle interior such as a steering wheel that is configured with a rim comprising a composite structure comprising at least one segment.

It would be advantageous to provide for a component for a vehicle interior such as a steering wheel that is configured with a rim comprising a composite structure comprising at least one segment that is configured for efficient assembly.

It would be advantageous to provide for a component for a vehicle interior such as a steering wheel that is configured with a rim comprising a composite structure comprising at least one segment that comprises sections configured for efficient assembly.

It would be advantageous to provide for a component for a vehicle interior such as a steering wheel that is configured with a rim comprising a composite structure comprising at least one segment that comprises sections configured to engage for efficient assembly onto the frame of the rim.

It would be advantageous to provide for a component for a vehicle interior such as a steering wheel that is configured with a rim comprising a composite structure comprising at least one segment that comprises a set of segments configured for efficient assembly.

It would be advantageous to provide for a component for a vehicle interior such as a steering wheel that is configured with a rim comprising a composite structure comprising at least one segment comprising a functional layer.

It would be advantageous to provide for a component for a vehicle interior such as a steering wheel that is configured with a rim comprising a composite structure comprising at least one segment comprising a functional layer in the form of a heating element or hands-off display sensor.

It would be advantageous to provide for a component for a vehicle interior such as a steering wheel that is configured with a rim comprising a composite structure comprising at least one segment comprising at least one functional segment configured to provide a user interface.

It would be advantageous to provide for a component for a vehicle interior such as a steering wheel that is configured with a rim comprising a composite structure comprising at least one segment comprising at least one functional segment comprising a functional layer.

It would be advantageous to provide for a component for a vehicle interior such as a steering wheel that is configured with a rim comprising a composite structure comprising at least one segment comprising at least one functional segment comprising a functional module.

### SUMMARY

The present invention relates to a component for a vehicle interior comprising a steering wheel comprising a frame; and a composite structure configured to be assembled on the frame. The composite structure may comprise a cover and a carrier. The composite structure may comprise a set of segments. A segment of the set of segments may comprise at least one of a decorative segment and/or a functional segment. The composite structure may comprise a rim; the rim may comprise the set of segments comprising the decorative segment and the functional segment; the rim may comprise a modular design. The functional segment may be configured to provide a user interface; operation of the user interface may comprise at least one of signaling, alerting, sensing, detecting, messaging, reporting. Operation of the user interface may comprise an output signal and/or an input signal. The output signal may comprise at least one of (a) light or (b) information display or (c) sound or (d) vibration or (e) haptic output. The input signal may comprise at least one of (a) touch or (b) sound or (c) a signal detected by a sensor. The component may comprise a control system configured to facilitate operation of at least one vehicle system through the user interface. The functional segment may comprise a sensor; the sensor may be configured to detect input from a vehicle occupant at or adjacent to the exterior surface of the cover from at least one of (a) touch, (b) pressure, (c) proximity, (d) position, (e) a switch. The functional segment may comprise a functional layer configured for at least one of (a) positioning, (b) spacing, (c) haptic feedback, (d) tactile feedback such as vibration, (c) audible feedback such as sound, (f) optical enhancement, (g) light shielding, (h) interaction with a vehicle system, (i) cushioning, (j) tactile shear/feel performance, (k) heating, (l) cooling, (m) diffusion of illumination from a display, (n) alerting, (o) messaging, (p) light guiding, (q) flexibility. The segment may comprise at least one of (a) a sensor and/or (b) a transducer and/or (c) a hands-off detector and/or (d) a heating element and/or (e) a haptic device. The set of segments may comprise a set of shell segments configured to be assembled on the frame. The functional segment may comprise a positioning layer comprising at least one of (a) a spacer, (b) a flexible spacer, (c) a spacer fabric, (d) a fabric material, (c) a foam material, (f) a plastic material, (g) a woven material, (h) a fiber material, (i) fabric, (j) polyurethane, (k) a spacer material.

The present invention relates to a component for a vehicle interior comprising a steering wheel configured to be attached to a base comprising a frame configured to be connected to the base; and a composite structure configured to be connected to the frame. The composite structure may comprise at least one segment comprising a cover. The composite structure may comprise a functional segment. The functional segment may comprise a sensor and/or a transducer. The sensor may comprise a hands-off sensor. The functional segment may comprise a heating element. The transducer may comprise at least one of (a) an audio speaker and/or (b) a microphone and/or (c) a haptic device. The functional segment may comprise a user interface; the user interface may comprise an input device and an output device. Operation of the user interface may comprise at least one of transmission of light, display of information, audio input, audio output, haptic feedback, health-sensing, heating, multi-functionality. The functional segment may comprise a functional module. The sensor may be configured to detect input from a vehicle occupant at or adjacent to an exterior surface of the cover. The set of segments may comprise a set of shell segments configured to be assembled in axial alignment on the frame; the set of shell segments may comprise a set of shell sections configured to be assembled in radial engagement around the frame.

The present invention relates to a component for a vehicle interior comprising a steering wheel comprising a composite structure assembled on a frame. The composite structure may comprise a cover and a carrier. The composite structure may comprise a set of segments comprising a decorative segment and/or a functional segment. The composite structure may comprise a rim comprising the set of segments. The functional segment may provide a user interface; operation of the user interface may comprise an output signal and/or an input signal; a control system may facilitate operation of a vehicle system through the user interface. The functional segment may comprise a transducer and/or sensor to detect input at/adjacent to the cover. The functional segment may comprise a functional module; the functional segment may comprise a functional layer; the functional segment may comprise a heating element and/or a hands-off detector and/or a positioning layer. The composite structure may comprise a modular design configured for efficient assembly and/or mass reduction.

The present invention relates to a component for a vehicle interior comprising a steering wheel comprising a frame; and a composite structure configured to be assembled on the frame. The composite structure may comprise a cover and a carrier. The composite structure may comprise set of segments. A segment of the set of segments may comprise at least one of a decorative segment and/or a functional segment. The composite structure may comprise a rim; the rim may comprise the set of segments comprising the decorative segment and the functional segment. A segment of the set of segments may comprise a functional segment. The functional segment may be configured to provide a user interface. The functional segment may be configured to provide a user interface for a vehicle occupant with vehicle systems and/or a telecommunication network. Operation of the user interface may comprise at least one of signaling, alerting, sensing, detecting, messaging, reporting. The user interface may be configured so that input from the vehicle occupant at an exterior surface of the cover is detected by a sensor. The user interface may be configured so that output from the display is presented at least partially through an exterior surface of the cover. Operation of the user interface may comprise an output signal and/or an input signal. The output signal may comprise at least one of (a) light or (b) information display or (c) sound or (d) vibration or (c) haptic output. The input signal may comprise at least one of (a) touch or (b) sound or (c) a signal detected by a sensor. The component may comprise a control system configured to connect the user interface to at least one vehicle system; the control system may be configured to facilitate operation by the vehicle occupant of at least one vehicle system. The component may comprise a control system for the user interface configured for at least one of (1) visible feedback, (2) audible feedback, (3) tactile feedback, (4) haptic feedback to the vehicle occupant. The functional segment may comprise a sensor. The functional segment may comprise a sensor configured to detect input from the vehicle occupant at or adjacent to an exterior surface of the cover. The functional segment may comprise a sensor; the sensor may be configured to detect input from the vehicle occupant at or adjacent to the exterior surface of the cover from at least one of (a) touch, (b) pressure, (c) proximity, (d) position. The sensor may be configured to represent a switch. The functional segment may comprise a functional layer configured for at least one of (a) positioning, (b) spacing, (c) haptic feedback, (d) tactile feedback such as vibration, (c) audible feedback such as sound, (f) optical enhancement, (g) light shielding, (h) interaction with a vehicle system, (i) cushioning, (j) tactile shear/feel performance, (k) heating, (l) cooling, (m) diffusion of illumination from the display, (n) alerting, (o) messaging, (p) light guiding, (q) flexibility. The functional segment may comprise a functional module comprising a transducer; the transducer may comprise at least one of (a) an audio speaker and/or (b) a microphone and/or (c) a haptic device. The carrier may comprise a substrate. The set of segments may comprise a set of shell sections; the set of shell sections may comprise a front section and a back section. The functional segment may comprise a positioning layer comprising at least one of (a) a spacer, (b) a flexible spacer, (c) a spacer fabric, (d) a fabric material, (c) a foam material, (f) a plastic material, (g) a woven material, (h) a fiber material, (i) fabric, (j) polyurethane, (k) a spacer material. The cover may comprise at least one of (a) textile, (b) fabric, (c) fiber mesh, (d) leather, (e) grained surface, (f) synthetic fibers, (g) natural fibers, (h) artificial leather, (i) polyester, (j) fabric sheet, (k) upholstered material, (l) a fleece material, (m) a woven material, (n) a non-woven material, (o) a sheet material, (p) a perforated material, (q) a composite of multiple fiber materials, (r) a translucent material, (s) a resilient material, (t) a leather material configured to facilitate the transmission of light, (u) a material that is partially transparent and partially opaque, (v) a layer configured to facilitate transmission of visible light, (w) a surface material perforated to improve the visibility of light from the display, (x) film, (y) resin, (z) a composite of multiple materials, (aa) a composite of fiber material, (bb) natural material, (cc) metal, (dd) a perforated material, (cc) a translucent layer. The composite structure may comprise a rim. The composite structure may comprise the frame.

The present invention relates to a component for a vehicle interior comprising a steering wheel configured to be attached to a base comprising a frame configured to be connected to the base; and a composite structure configured to be connected to the frame. The composite structure may comprise at least one segment comprising a cover. The composite structure may comprise a functional segment. The functional segment may comprise at least one of (a) a sensor and/or (b) a transducer. The sensor may comprise a hands-off sensor. The functional segment may comprise a heating element. The transducer may comprise at least one of (a) an audio speaker and/or (b) a microphone and/or (c) a haptic device. The functional segment may comprise a user interface; the user interface may comprise an input device and an output device. The user interface may comprise connectivity with vehicle systems and/or a network. The component may comprise a control system for the user interface. Operation of the user interface may comprise at least one of transmission of light, display of information, audio input, audio output, haptic feedback, health-sensing, heating, multi-functionality. The user interface may be connected to at least one vehicle system and/or to a network and/or to a device. The cover may comprise a cover layer. The at least one segment may comprise at least one shell segment. The functional segment may comprise a functional module; the functional module may comprise at least one of a light and/or a display. The light may comprise an LED element. The light may comprise a set of LED elements. The sensor may be configured to detect input from the vehicle occupant at or adjacent to the exterior surface of the cover. The sensor may be configured to represent a switch configured to operate a vehicle system. The set of segments may comprise a decorative segment and the functional segment. The composite structure may comprise a cover and a positioning layer. The decorative segment may comprise the cover. The functional segment may comprise a functional layer under the cover. The composite structure may comprise an intermediate layer under the cover. The composite structure may comprise a rim. The composite structure may comprise the frame. The frame may comprise an armature. A segment of the composite structure may be configured to provide a cavity between the frame and the segment; the cavity may be configured to accommodate cables, wires, LEDs or electronic components. The set of segments of the composite structure may comprise at least one of exchangeable elements and/or replaceable elements and/or selectable elements.

The present invention relates to a component for an interior of a vehicle comprising a steering wheel comprising a base and a rim. The rim may comprise a composite structure and a frame connected to the base. The composite structure of the rim may comprise at least one segment comprising a cover and an intermediate layer under the cover. The cover layer may comprise an exterior surface for the rim. The intermediate layer may comprise at least one of a soft material or a resilient material. The intermediate layer may comprise at least one of a foam material or a spacer material. The component may comprise a carrier on the frame. The carrier may comprise a carrier layer beneath the intermediate layer. The intermediate layer may comprise a carrier layer. The at least one segment may comprise at least one shell segment. The at least one segment may comprise an engagement portion. The at least one segment may comprise a set of segments. The set of segments may comprise a set of selectable segments configured to be assembled onto the frame of the rim. The rim may comprise a multi-segment construction comprising the set of segments. The rim may comprise a multi-segment construction comprising the set of selectable segments. The at least one segment may comprise a first segment and a second segment; the first segment may be axially connected to the second segment. The at least one segment may comprise a set of segments; the set of segments may comprise a first segment and a second segment; the cover layer on the first segment may be different than the cover layer on the second segment. The at least one segment may comprise a set of segments; the set of segments may comprise a first segment and a second segment; the first segment may be different than the second segment. The at least one segment may comprise a set of segments; each segment of the set of segments may comprise a segment base. Each segment of the set of segments may comprise an engagement portion. When the set of segments is assembled onto the frame the engagement portion of a first segment may be connected at the engagement portion of a second segment. When the set of segments is assembled onto the frame the engagement portion of a first segment may be clipped to the engagement portion of a second segment. When the set of segments is assembled onto the frame the engagement portion of a first segment may be connected at the engagement portion of a second segment in axial alignment. The engagement portion may comprise a connector and/or a plurality of connectors. The connector may comprise a clip connector. The connector may comprise a snap-fit connector. The engagement portion may comprise at least one of a projection and a receptacle for the projection. The connector may comprise a snap-fit connector comprising a projection and a receptacle for the projection. The at least one segment may comprise a set of shell segments. The set of shell segments may comprise a first shell section and a second shell section. When the set of shell segments is assembled onto the frame the first shell section may be attached to the second shell section. When the set of shell segments is assembled onto the frame the first shell section may be attached to the second shell section in radial alignment. The at least one shell segment may comprise a first shell section and a second shell section. The at least one shell segment may comprise a first shell section and a second shell section; the first shell section may be radially connected to the second shell section. The first shell section may comprise a first engagement portion; the second shell section may comprise a second engagement portion configured to engage the first engagement portion of the first shell section. The cover layer may comprise a decorative layer. The composite structure may comprise a positioning element. The at least one segment may comprise a positioning element. The cover may be configured to provide a visual effect for the rim. The cover may comprise a cover layer comprising at least one of a fabric material, a textile material, a fiber material, a leather, a synthetic leather material, a foil, a skin, a wrap, a vencer, a recycled material, an opaque material, a light-transmissive material. The cover layer may comprise a no-stitch appearance. The composite structure may be configured to provide a visual effect for the rim. The visual effect may comprise a multi-segment appearance. The visual effect may comprise a multi-section appearance. The visual effect may comprise a multi-tone appearance. The visual effect may comprise a no-stitch appearance. The visual effect may comprise a modular appearance. The at least one segment may comprise a first segment and a second segment; the cover of the first segment may be different from the cover of the second segment. The component may comprise a spoke structure connecting the rim to the base. The component may comprise a functional layer; the functional layer may comprise at least one of (a) a sensor for hands-off detection or (b) heating mat. The base may comprise an airbag module. The frame may comprise an armature. The base may comprise a cover; the cover may provide a logo. The composite structure may be configured for mass/weight reduction.

The present invention relates to a component for an interior of a vehicle comprising a steering wheel comprising a base and a rim. The rim may comprise a composite structure and a frame connected to the base. The composite structure of the rim may comprise at least one segment comprising a cover and an intermediate layer under the cover. The composite structure may be configured to provide a visual effect for the rim. The at least one segment may comprise a set of segments. The visual effect may comprise a multi-segment appearance provided by the set of shell segments. The composite structure may be configured to provide a tactile effect. The set of segments may comprise a set of shell segments. The visual effect may comprise a multi-segment appearance. The visual effect may comprise a multi-section appearance. The visual effect may comprise a multi-tone appearance. The visual effect may comprise a no-stitch appearance. The cover may comprise a cover layer. The cover layer may be configured to provide the visual effect for the rim. The cover layer may comprise at least one of a fabric material, a textile material, a fiber material, a leather, a synthetic leather material, a foil, a skin, a wrap, a vencer, a recycled material, an opaque material, a light-transmissive material. The cover layer may comprise a no-stitch appearance. The intermediate layer may comprise at least one of a foam material or a spacer material. The intermediate layer may comprise a carrier layer on the frame. The at least one segment may comprise an engagement portion. The at least one segment may comprise a set of shell segments. The set of shell segments may comprise a set of selectable shell segments configured to be assembled onto the frame of the rim. The rim may comprise a multi-segment construction comprising the set of shell segments. The set of segments may comprise a first segment and a second segment; the cover on the first segment may be different than the cover on the second segment. The set of segments may comprise a first segment and a second segment; the first segment may be different than the second segment. The set of segments may be assembled onto the frame in axial alignment. The set of segments may be assembled onto the frame in axial alignment at an engagement portion. The engagement portion may comprise a connector for each segment of the set of segments. The connector may comprise a snap-fit connector comprising a projection and a receptacle for the projection. The at least one segment may comprise a first shell section and a second shell section. When the set of segments is assembled onto the frame the first shell section may be attached to the second shell section in radial alignment. The first shell section may comprise a first engagement portion; the second shell section may comprise a second engagement portion configured to engage the first engagement portion of the first shell section.

The present invention relates to a component for an interior of a vehicle comprising a steering wheel comprising a base and a rim. The rim may comprise a composite structure and a frame connected to the base. The composite structure of the rim may comprise at least one segment comprising a cover layer and an intermediate layer under the cover layer. The composite structure may comprise a functional layer. The functional layer may comprise at least one of (a) sensor or (b) a transducer or (c) a light. The sensor may comprise at least one of (a) capacitive sensor or (b) an infrared sensor or (c) an ultrasonic sensor (d) conductive sensor or (e) light. The at least one segment may be configured for integration of the functional layer. The at least one segment may be configured for interconnection of the functional layer. The composite structure may comprise a connector for the functional layer. The base may comprise a control module for the functional layer. The composite structure may comprise a positioning element. The at least one segment may comprise a positioning element. The positioning element may be configured to facilitate connectivity for the functional layer. The positioning element may be configured to facilitate positioning of the cover layer relative to the frame. The base may comprise an airbag module. The frame may comprise an armature. The base may comprise a horn module.

The present invention relates to a component for an interior of a vehicle comprising a steering wheel comprising a base and a rim. The rim may comprise a composite structure and a frame connected to the base. The composite structure of the rim may comprise at least one segment comprising a cover and an intermediate layer under the cover. The composite structure may comprise a functional layer. The functional layer may comprise at least one of (a) a sensor and/or (b) a transducer and/or (c) a hands-off sensor and/or (d) a heating element. The transducer may comprise at least one of (a) an audio speaker and/or (b) a microphone and/or (c) a haptic device. The functional layer may comprise a user interface. The cover may comprise a cover layer. The at least one segment may comprise at least one shell segment.

The present invention relates to a component for an interior of a vehicle configured to provide a user interface for a vehicle occupant in a vehicle comprising vehicle systems comprising a steering wheel comprising a base and a rim. The rim may comprise a composite structure and a frame connected to the base. The composite structure of the rim may comprise at least one shell segment comprising a cover and an intermediate layer under the cover. The rim may comprise a functional module. The functional module may comprise at least one of (a) a sensor and/or (b) transducer and/or (c) a hands-off sensor and/or (d) a heating element and/or (e) a light and/or (f) a display. The functional module may comprise the display; the display may comprise a display panel. The light may comprise a light panel. The light may comprise an LED element. The light may comprise a set of LED elements. The transducer may comprise at least one of (a) an audio speaker and/or (b) a microphone and/or (c) a haptic device. The sensor may comprise a hand-off detector. The sensor may be configured to detect health-related information. Health-related information may comprise a signal representative of at least one of heart rate, blood oxygen saturation, sweat, temperature. The sensor may comprise an ECG (electrocardiograph) electrode to measure heart condition such as heart rate, heart rate variability. The sensor may comprise a PPG (photoplethysmography) optical sensor to measure blood oxygen saturation. The sensor may comprise an EDA sensor to measure skin potential, skin DC conductance, and skin AC admittance. The sensor may be configured to detect input from the vehicle occupant at or adjacent to the exterior surface of the cover. The sensor may be configured to represent a switch. The switch may be configured to operate a vehicle system. The user interface may be connected to at least one vehicle system. The user interface may be connected to a network. The user interface may be connected to a network using telecommunication protocols. The network may comprise the internet. The user interface may be configured to be connected to a device. The device may comprise a mobile device. The mobile device may comprise a telecommunication device connected to a network. The telecommunication device may comprise a smart phone. The functional module may comprise a functional layer for the composite structure. The functional layer may comprise at least one of (a) a sensor and/or (b) a transducer and/or (c) a hands-off sensor and/or (d) a heating element. The functional layer may be configured under the cover. The functional layer may comprise a light source and the cover may comprise a light-transmissive cover layer. The functional module may comprise a light source configured to transmit light through the cover. The functional module may comprise a functional layer. The functional layer may comprise a light guide configured to transmit light. The functional layer may comprise a light guide configured to transmit light through the cover. The functional layer may comprise a light guide configured to transmit light from a light source. The functional module may comprise a display configured to provide illumination at least partially visible at the cover. Operation of the user interface for the vehicle occupant may comprise at least one of (a) an output signal (b) an input signal. The output signal may comprise at least one of (a) light or (b) information display or (c) sound or (d) vibration or (c) haptic output. The input signal may comprise at least one of (a) touch or (b) sound or (c) a signal detected by a sensor. The at least one segment may comprise a set of segments on the frame; the set of segments may comprise a functional segment comprising a functional module. The at least one segment may comprise a set of shell sections; the set of shell sections may comprise a front section and a back section. The at least one segment may comprise a decorative segment. The cover may comprise a decorative layer. The at least one segment may comprise a functional segment. The functional segment may comprise a functional layer. The user interface may comprise an input device and an output device. The user interface may comprise connectivity with vehicle systems and/or a network. The component may comprise a controller for the user interface. The component may comprise a control system for the user interface. The user interface may comprise at least one of signaling, alerting, sensing, detecting, messaging, reporting. The user interface may comprise at least one of transmission of light, display of information, audio input, audio output, haptic feedback, health-sensing, heating, multi-functionality. The composite structure may comprise at least one of a light source, an LED, a LED arrangement, a display, a display panel. The user interface may be configured for at least one of connectivity to a vehicle system, connectivity to a network, connectivity to a mobile device, connectivity to a component, connectivity to a communication network, connectivity to the internet.

The present invention relates to a component for an interior of a vehicle comprising a steering wheel comprising a base and a rim. The rim may comprise a composite structure. The composite structure may comprise a frame and a set of segments on the frame. The composite structure may comprise a cover and a positioning layer. Each segment of the set of segments may comprise at least one of a decorative segment and a functional segment. The functional segment may comprise a sensor. The functional segment may comprise a functional layer. The functional segment may comprise a functional module. The functional segment may be configured to provide a user interface for a vehicle occupant with vehicle systems and/or a telecommunication network. The cover may comprise an exterior surface. The functional segment may comprise the sensor. The functional segment may comprise a light display. The functional segment may comprise a functional layer. The composite structure may comprise a positioning layer. The cover may comprise a layer configured to facilitate the transmission of light. The sensor may be configured to detect input from the vehicle occupant at or adjacent to the exterior surface of the cover. The light display may be configured to provide illumination at least partially visible through the exterior surface of the cover. Operation of the user interface for a vehicle occupant may comprise at least one of output from illumination from the display and (b) input detected by the sensor. The composite structure may comprise (a) the cover, (b) the functional layer, (c) the sensor, (d) the positioning layer, (c) the display, (f) a substrate. The positioning layer may comprise at least one of (a) a foam material and/or (b) a spacer fabric. The cover may comprise at least one of (a) textile, (b) fabric, (c) fiber mesh, (d) leather, (e) grained surface, (f) synthetic fibers, (g) natural fibers, (h) artificial leather, (i) polyester, (j) fabric sheet, (k) upholstered material, (l) a fleece material, (m) a woven material, (n) a non-woven material, (o) a sheet material, (p) a perforated material, (q) a composite of multiple fiber materials, (r) a translucent material, (s) a resilient material, (t) a leather material configured to facilitate the transmission of light, (u) a material that is partially transparent and partially opaque, (v) a layer configured to facilitate transmission of visible light, (w) a surface material perforated to improve the visibility of light from the display. The cover may comprise a light-transmissive cover comprising at least one of (a) film, (b) resin, (c) polycarbonate, (d) polyurethane, (e) polyvinyl material, (f) TPO, (g) a polymeric material, (h) a polymeric film, (i) a composite of multiple plastic materials, (j) a composite of multiple materials, (k) a composite of fiber material, (l) natural material, (m) metal, (n) a perforated material, (o) a translucent layer. The functional layer may be configured for at least one of (a) positioning, (b) spacing, (c) haptic feedback, (d) tactile feedback such as vibration, (c) audible feedback such as sound, (f) optical enhancement, (g) light shielding, (h) interaction with a vehicle system, (i) cushioning, (j) tactile shear/feel performance, (k) heating, (l) cooling, (m) diffusion of illumination from the display, (n) alerting, (o) messaging, (p) light guiding, (q) flexibility. The positioning layer may be configured to retain positioning within the composite structure for operation of the sensor from input from the vehicle occupant; the positioning layer may comprise at least one of (a) a spacer, (b) a flexible spacer, (c) a spacer fabric, (d) a foam material, (c) a plastic material, (f) fabric, (g) polyurethane, (h) a woven material, (i) a spacer material, (j) a fabric material, (k) a fiber material. The user interface may be configured so that input from the vehicle occupant at the exterior surface of the cover is detected by the sensor. The user interface may be configured so that output from the display is presented at least partially through the exterior surface of the cover. The composite structure may comprise a substrate. The substrate may comprise a carrier. The component may comprise a control system configured to connect the user interface to at least one vehicle system; the control system may be configured to facilitate operation by the vehicle occupant of at least one vehicle system. The component may comprise a control system for the user interface configured for at least one of (1) visible feedback, (2) audible feedback, (3) tactile feedback, (4) haptic feedback to the vehicle occupant. The user interface may be configured for interaction with a vehicle occupant by at least one of (a) touch at the exterior surface of the cover detected by the sensor or (b) gesture adjacent to the exterior surface of the cover detected by the sensor. The sensor may comprise at least one of (a) an array, (b) a grid, (c) a foil, (d) a panel, (c) a touch panel, (f) a flexible panel, (g) a detector, (h) a proximity detector, (i) a capacitive touch panel, (j) a pressure sensitive panel. The user interface may comprise a light display; the light display may comprise at least one of (a) an array, (b) a panel, (c) a flexible panel. The composite structure may comprise a composite surface; the cover may comprise an at least partially translucent cover; illumination from the display at the exterior surface of the composite structure may comprise visible light transmitted through the functional layer and through the at least partially translucent cover. The sensor may be configured to detect input from the vehicle occupant at or adjacent to the exterior surface of the cover. The functional segment may comprise a functional layer configured for at least one of (a) positioning, (b) spacing, (c) haptic feedback, (d) tactile feedback such as vibration, (e) audible feedback such as sound, (f) optical enhancement, (g) light shielding, (h) interaction with a vehicle system, (i) cushioning, (j) tactile shear/feel performance, (k) heating, (l) cooling, (m) diffusion of illumination from the display, (n) alerting, (o) messaging, (p) light guiding, (q) flexibility. The sensor may be configured to detect input from the vehicle occupant at or adjacent to the exterior surface of the cover from at least one of (a) touch, (b) pressure, (c) proximity, (d) position. The positioning layer may comprise at least one of (a) a spacer, (b) a flexible spacer, (c) a spacer fabric, (d) a fabric material, (e) a foam material, (f) a plastic material, (g) a woven material, (h) a fiber material, (i) fabric, (j) polyurethane, (k) a spacer material. The cover may comprise at least one of (a) textile, (b) fabric, (c) fiber mesh, (d) leather, (c) grained surface, (f) synthetic fibers, (g) natural fibers, (h) artificial leather, (i) polyester, (j) fabric sheet, (k) upholstered material, (l) a fleece material, (m) a woven material, (n) a non-woven material, (o) a sheet material, (p) a perforated material, (q) a composite of multiple fiber materials, (r) a translucent material, (s) a resilient material, (t) a leather material configured to facilitate the transmission of light, (u) a material that is partially transparent and partially opaque, (v) a layer configured to facilitate transmission of visible light, (w) a surface material perforated to improve the visibility of light from the display, (x) film, (y) resin, (z) a composite of multiple materials, (aa) a composite of fiber material, (bb) natural material, (cc) metal, (dd) a perforated material, (ce) a translucent layer.

The present invention relates to a component for an interior of a vehicle comprising a rim configured to be assembled on a steering wheel comprising a frame; the rim may comprise a composite structure; the composite structure may comprise a set of segments to be assembled on the frame; the composite structure may comprise a cover and a carrier; a segment of the set of segments may comprise at least one of a decorative segment and/or a functional segment. The composite structure may comprise a positioning layer. The segment may comprise a manufactured segment and/or replaceable segment and/or an exchangeable segment and/or spare part segment. The segment may be configured to provide a cavity between the frame and the segment; the cavity may be configured to accommodate cables, wires, LEDs or electronic components. The segment of the composite structure may comprise a manufactured element and/or an exchangeable element and/or a replaceable element and/or a selectable element and/or a spare part segment. The segment may comprise a segment shell section configured to be attached by (a) by mechanical fastening and/or (b) by glue and/or (c) by ultrasonic welding; the segment shell section may be configured to be attached to an adjacent segment shell section by (a) by mechanical fastening and/or (b) by glue and/or (c) by ultrasonic welding. The component may be formed by a method of manufacturing comprising the steps of forming a base and a rim; providing a frame; providing a composite structure. The composite structure may be configured to provide a segmented cover; such that the steering wheel assembly comprises connecting the segmented covers and the frame. The connection may comprise at least one of clipping, latching, bonding, or welding.

The present invention relates to a steering wheel of a type providing a base and a frame comprising a rim comprising a composite structure connected to the base. The composite structure of the rim may comprise at least one shell segment comprising a cover layer and an intermediate layer under the cover layer. The cover layer may comprise an exterior surface for the rim. The intermediate layer may comprise at least one of a soft material or a resilient material. The intermediate layer may comprise at least one of a foam material or a spacer material. The intermediate layer may comprise a carrier layer on the frame. The intermediate layer may comprise a carrier layer on the frame and at least one of soft material or a resilient material or a foam material or a spacer material. The at least one shell segment may comprise an engagement portion. The at least one shell segment may comprise a set of shell segments. The set of shell segments may comprise a set of selectable shell segments configured to be assembled onto the frame of the rim. The rim may comprise a multi-segment construction comprising the set of shell segments. The rim may comprise a multi-segment construction comprising a set of selectable shell segments. The set of shell segments may comprise a first segment and a second segment; the cover layer on the first segment may be different than the cover layer on the second segment. The set of shell segments may comprise a first segment and a second segment; the first segment may be different than the second segment. Each segment of the set of shell segments may comprise a shell segment base. Each shell segment of the set of shell segments may comprise an engagement portion. When the set of shell segments is assembled onto the frame the engagement portion of a first shell segment may be connected at the engagement portion of a second shell segment. When the set of shell segments is assembled onto the frame the engagement portion of a first shell segment may be snap-fit connected at the engagement portion of a second shell segment. When the set of shell segments is assembled onto the frame the engagement portion of a first shell segment may be connected at the engagement portion of a second shell segment in axial alignment. The engagement portion may comprise a connector and/or a plurality of connectors. The connector may comprise a snap-fit connector. The connector may comprise a snap-fit connector comprising a projection and a receptacle for the projection. The engagement portion may comprise at least one of a projection or a receptacle for the projection. The at least one shell segment may comprise a first shell section and a second shell section. When the set of shell segments is assembled onto the frame the first shell section may be attached to the second shell section. When the set of shell segments is assembled onto the frame the first shell section may be attached to the second shell section in radial alignment. The at least one shell segment may comprise a first shell section and a second shell section. The first shell section may comprise a first engagement portion; the second shell section may comprise a second engagement portion configured to engage the first engagement portion of the first shell section. The cover layer may comprise a decorative layer. The composite structure may comprise a positioning element. The at least one shell segment may comprise a positioning element. The cover layer may be configured to provide a visual effect for the rim and/or a tactile effect for the rim. The cover layer may comprise at least one of a fabric material, a textile material, a fiber material, a leather, a synthetic leather material, a foil, a skin, a wrap, a vencer, a recycled material. The composite structure may be configured to provide a visual effect for the rim. The visual effect may comprise a multi-segment appearance. The visual effect may comprise a multi-section appearance. The visual effect may comprise a multi-tone appearance. The visual effect may comprise a modular appearance. The at least one segment may comprise a first segment and a second segment; the cover layer of the first segment may be different from the cover layer of the second segment. The steering wheel may comprise a spoke structure connecting the rim to the base. The steering wheel may comprise a functional layer; the functional layer may comprise at least one of a (a) sensor for hands-off detection or (b) heating mat. The base may comprise an airbag module. The frame may comprise an armature. The base may comprise a cover; the cover may provide a logo.

The present invention relates to a steering wheel of a type providing a base and a frame comprising a rim comprising a composite structure connected to the base. The composite structure of the rim may comprise at least one shell segment comprising a cover layer and an intermediate layer under the cover layer. The composite structure may be configured to provide a visual effect for the rim. The at least one shell segment may comprise a set of shell segments. The visual effect may comprise a multi-segment appearance provided by the set of shell segments. The visual effect may comprise a multi-segment appearance. The visual effect may comprise a multi-section appearance. The visual effect may comprise a multi-tone appearance. The cover layer may be configured to provide the visual effect for the rim. The cover layer may comprise at least one of a fabric material, a textile material, a fiber material, a leather, a synthetic leather material, a foil, a skin, a wrap, a veneer, a recycled material. The intermediate layer may comprise at least one of a foam material or a spacer material. The intermediate layer may comprise a carrier layer on the frame. The at least one shell segment may comprise an engagement portion. The at least one shell segment may comprise a set of shell segments. The set of shell segments may comprise a set of selectable shell segments configured to be assembled onto the frame of the rim. The rim may comprise a multi-segment construction comprising the set of shell segments. The set of shell segments may comprise a first segment and a second segment; the cover layer on the first segment may be different than the cover layer on the second segment. The set of shell segments may comprise a first segment and a second segment; the first segment may be different than the second segment. The set of shell segments may be assembled onto the frame in axial alignment. The set of shell segments may be assembled onto the frame in axial alignment at an engagement portion. The engagement portion may comprise a connector for each shell segment of the set of shell segments. The connector may comprise a snap-fit connector comprising a projection and a receptacle for the projection. The at least one shell segment may comprise a first shell section and a second shell section. The set of shell segments may be assembled onto the frame; the first shell section may be attached to the second shell section in radial alignment. The first shell section may comprise a first engagement portion; the second shell section may comprise a second engagement portion configured to engage the first engagement portion of the first shell section.

The present invention relates to a steering wheel of a type providing a base and a frame comprising a rim comprising a composite structure connected to the base. The composite structure of the rim may comprise at least one shell segment comprising a cover layer and an intermediate layer under the cover layer. The composite structure may comprise a functional layer. The functional layer may comprise at least one of (a) a hands-off sensor or (b) a heating element. The at least one shell segment may be configured for integration of the functional layer. The at least one shell segment may be configured for interconnection of the functional layer. The composite structure may comprise a connector for the functional layer. The base may comprise a control module for the functional layer. The composite structure may comprise a positioning element. The at least one shell segment may comprise a positioning element. The positioning element may be configured to facilitate connectivity for the functional layer. The base may comprise an airbag module. The frame may comprise an armature. The base may comprise a horn module.

### FIGURES

FIG. 1A is a schematic perspective views of a vehicle according to an exemplary embodiment.

FIG. 1B is a schematic perspective views of a vehicle interior according to an exemplary embodiment.

FIGS. 2A through 2D are schematic perspective views of a component shown as a steering wheel with rim according to an exemplary embodiment.

FIGS. 3A through 3L are schematic diagrams of a component shown as a steering wheel according to an exemplary embodiment.

FIGS. 4A through 4I are schematic diagrams of a component shown as a steering wheel according to an exemplary embodiment.

FIGS. 5A through 5L are schematic diagrams of a component shown as a steering wheel according to an exemplary embodiment.

FIGS. 6A and 6B are schematic perspective views of a component shown as a steering wheel with rim according to an exemplary embodiment.

FIG. 7 is a schematic exploded perspective view of a component shown as a steering wheel with rim according to an exemplary embodiment.

FIG. 8A is a schematic perspective view of a component shown as a steering wheel with rim according to an exemplary embodiment.

FIG. 8B is a schematic exploded perspective view of a component shown as a steering wheel with rim according to an exemplary embodiment.

FIGS. 9A through 9C are schematic fragmentary perspective views of a component shown as a steering wheel with rim according to an exemplary embodiment.

FIGS. 10A through 10C are schematic fragmentary perspective views of a component shown as a steering wheel with rim according to an exemplary embodiment.

FIG. 11A is a schematic diagram of a component shown as a steering wheel according to an exemplary embodiment.

FIGS. 11B through 11D are schematic cross-section views of a rim of a steering wheel according to an exemplary embodiment.

FIGS. 12A and 12D are schematic cross-section views of a rim of a steering wheel according to an exemplary embodiment.

FIGS. 12B and 12E are schematic fragmentary perspective views of a rim of a steering wheel according to an exemplary embodiment.

FIG. 12C is a schematic perspective view of an element of a rim of a steering wheel according to an exemplary embodiment.

FIG. 13A is a schematic exploded perspective view of a composite structure of a rim of a steering wheel according to an exemplary embodiment.

FIG. 13B is a schematic exploded cross-section view of a composite structure of a rim of a steering wheel according to an exemplary embodiment.

FIG. 13C is a schematic exploded partial cross-section view of a composite structure of a rim of a steering wheel according to an exemplary embodiment.

FIG. 13D is a schematic cross-section view of a composite structure of a rim of a steering wheel according to an exemplary embodiment.

FIG. 14A is a schematic exploded perspective view of a composite structure of a rim of a steering wheel according to an exemplary embodiment.

FIG. 14B is a schematic exploded cross-section view of a composite structure of a rim of a steering wheel according to an exemplary embodiment.

FIG. 14C is a schematic exploded partial cross-section view of a composite structure of a rim of a steering wheel according to an exemplary embodiment.

FIG. 14D is a schematic cross-section view of a composite structure of a rim of a steering wheel according to an exemplary embodiment.

FIG. 15A is a schematic exploded perspective view of a composite structure of a rim of a steering wheel according to an exemplary embodiment.

FIG. 15B is a schematic exploded cross-section view of a composite structure of a rim of a steering wheel according to an exemplary embodiment.

FIG. 15C is a schematic exploded partial cross-section view of a composite structure of a rim of a steering wheel according to an exemplary embodiment.

FIG. 15D is a schematic cross-section view of a composite structure of a rim of a steering wheel according to an exemplary embodiment.

FIGS. 16A through 16F are schematic partial perspective views of a composite structure of a rim of a steering wheel according to an exemplary embodiment.

FIGS. 17A and 17B are schematic exploded views of a steering wheel with a functional module and control module according to an exemplary embodiment.

FIGS. 18A and 18B are schematic exploded views of a steering wheel with a functional module and control module according to an exemplary embodiment.

FIG. 19A is a schematic exploded perspective view of a composite structure of a rim of a steering wheel according to an exemplary embodiment.

FIG. 19B is a schematic exploded cross-section view of a composite structure of a rim of a steering wheel according to an exemplary embodiment.

FIG. 19C is a schematic exploded partial cross-section view of a composite structure of a rim of a steering wheel according to an exemplary embodiment.

FIG. 19D is a schematic cross-section view of a composite structure of a rim of a steering wheel according to an exemplary embodiment.

FIGS. 20A through 20E are schematic partial perspective views of a composite structure of a rim of a steering wheel according to an exemplary embodiment.

FIG. 21A is a schematic exploded perspective view of a composite structure of a rim of a steering wheel according to an exemplary embodiment.

FIGS. 21B and 21D are schematic exploded cross-section view of a composite structure of a rim of a steering wheel according to an exemplary embodiment.

FIG. 21C is a schematic exploded partial cross-section view of a composite structure of a rim of a steering wheel according to an exemplary embodiment.

FIG. 21E is a schematic cross-section view of a composite structure of a rim of a steering wheel according to an exemplary embodiment.

FIGS. 22A and 22B are schematic partial perspective views of a composite structure of a rim of a steering wheel according to an exemplary embodiment.

FIG. 22C is a schematic cross-section view of a composite structure of a rim of a steering wheel according to an exemplary embodiment.

FIGS. 23A and 23B are schematic partial perspective views of a composite structure of a rim of a steering wheel according to an exemplary embodiment.

FIG. 23C is a schematic cross-section view of a composite structure of a rim of a steering wheel according to an exemplary embodiment.

FIG. 24A is a schematic cross-section view of a composite structure for forming for assembly on a rim of a steering wheel according to an exemplary embodiment.

FIGS. 24B and 24C are schematic cross-section views of operation of an apparatus for forming a composite structure into a rim for a steering wheel according to an exemplary embodiment.

FIG. 24D is a schematic perspective view of a composite structure for forming for assembly on a rim of a steering wheel according to an exemplary embodiment.

FIGS. 25A through 25E are schematic cross-section views of operation of an apparatus for forming a composite structure into a rim for a steering wheel according to an exemplary embodiment.

FIG. 25F is a schematic cross-section view of a composite structure of a rim of a steering wheel according to an exemplary embodiment.

FIGS. 26A and 26B are schematic block diagrams of a user interface system for operation of a steering wheel comprising a functional module and a control module according to an exemplary embodiment.

FIG. 27 is a schematic block diagram of a user interface system for operation of a steering wheel comprising a functional module and a control module according to an exemplary embodiment.

FIG. 28 is a schematic block diagram of a user interface system for operation of a steering wheel comprising a functional module and a control module according to an exemplary embodiment.

FIG. 29 is a schematic block diagram of a user interface system for operation of a steering wheel comprising a functional module and a control module according to an exemplary embodiment.

FIG. 30 is a schematic block diagram of a user interface system for operation of a steering wheel comprising a functional module and a control module according to an exemplary embodiment.

FIG. 31 is a schematic block diagram of a user interface system for operation of a steering wheel comprising a functional module and a control module according to an exemplary embodiment.

FIG. 32 is a schematic block diagram of a user interface system for operation of a steering wheel comprising a functional module and a control module according to an exemplary embodiment.

FIGS. 33A and 33B are schematic block diagrams of a user interface system for operation of a steering wheel comprising a functional module and a control module according to an exemplary embodiment.

FIGS. 34A through 34E are schematic flow diagrams of a method for forming a composite structure into a rim for a steering wheel according to an exemplary embodiment.

### DESCRIPTION

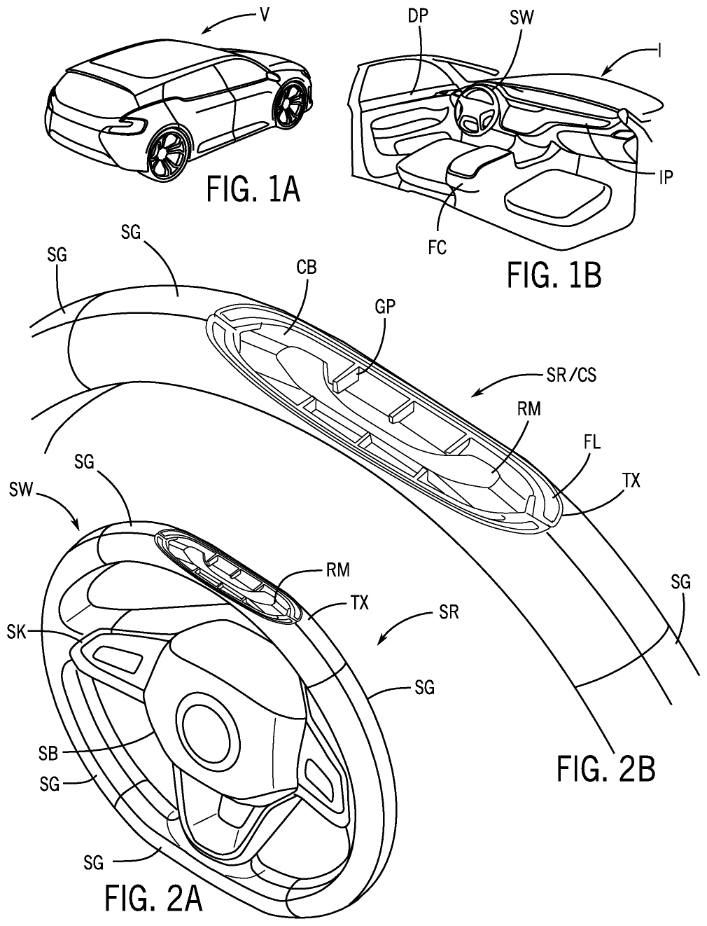

Referring to FIGS. 1A-1B, a vehicle V is shown with an interior I comprising components including trim panels such as instrument panel IP and a door panel DP and a console shown as floor console FC and a steering wheel SW.

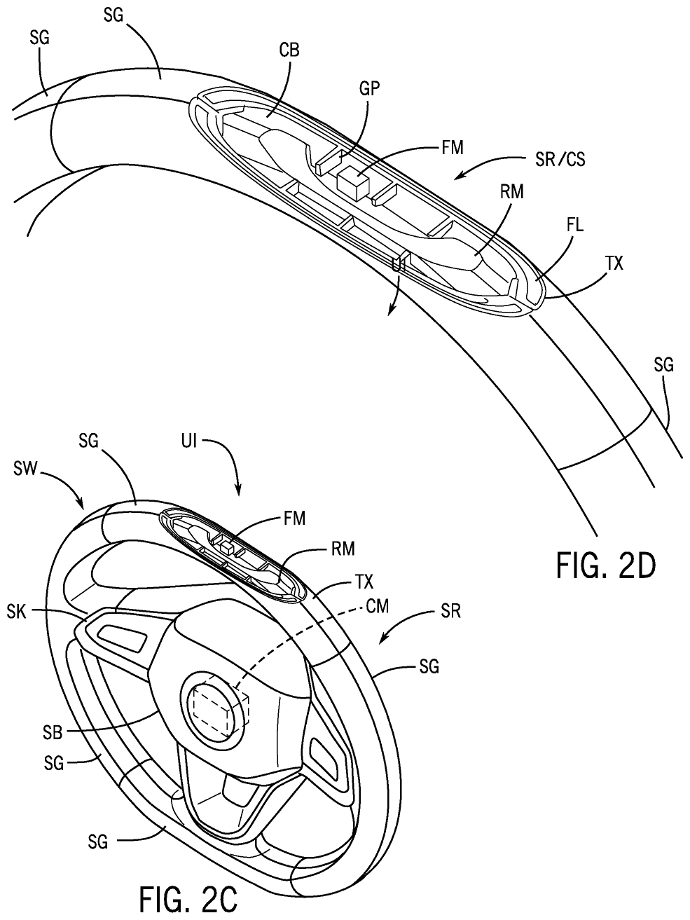

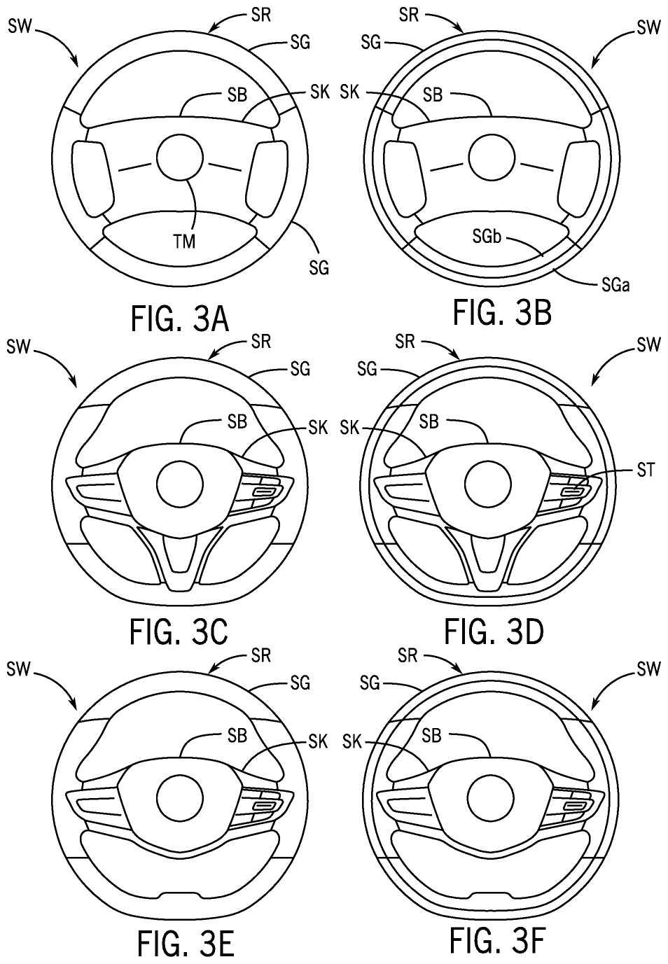

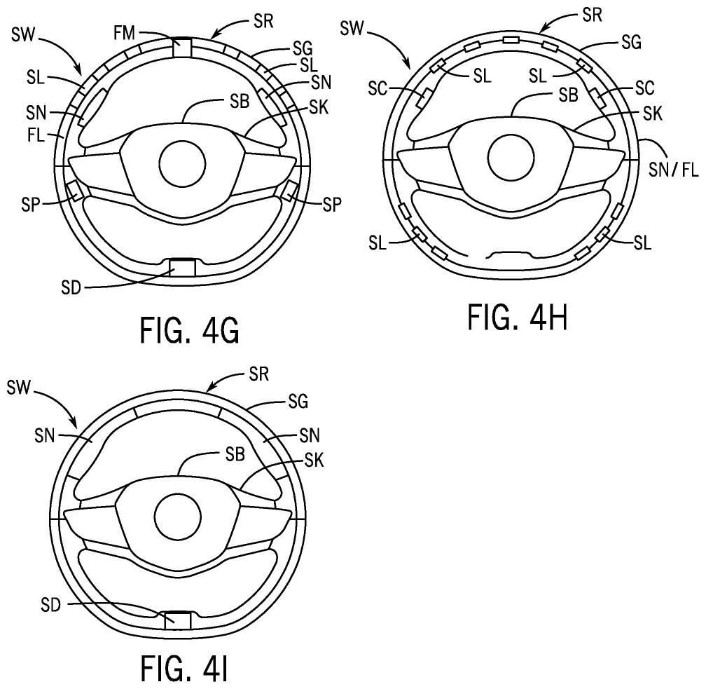

According to an exemplary embodiment as shown schematically in FIGS. 2A-2D and 6A-6B, the steering wheel SW may comprise a base section SB (with an emblem/logo TM) and a spoke structure SK with a rim SR; rim SR may comprise a composite structure CS assembled on a frame RM; rim SR/CS may comprise a set of segments SG (shown as shell segments SGa and SGb); segments SG may comprise a cover TX providing an exterior/cover layer (shown as functional layer and/or decorative layer FL/DL) and a positioning element GP on a base/carrier CB. See also FIGS. 3A-3L, 4A-4I and 5A-5L.

As indicated schematically in FIGS. 3A-3J and 6A-6B, steering wheel SW may be provided in any of a wide variety of configurations of base SB and/or spokes SK and/or rim SR with segments SG; as indicated schematically, rim SR may comprise any of a wide variety of configurations of segments SG; segments SG may be provided in any of a wide variety of configurations. As indicated schematically in FIGS. 3A, 3C, 3E, 3G and 31, 6B, rim SR may comprise segments SG in an axially-arranged orientation (e.g. adjacent segments/sections); as indicated schematically in FIGS. 3B, 3D, 3F, 3H, 3J and 6A, rim SR may comprise segments with sections in a radial arrangement (e.g. segment shell sections SGa and SGb configured to be assembled onto the frame of the rim SR).

According to an exemplary embodiment as shown schematically in FIGS. 2A-2B, 4A-4I and 5A-5L, steering wheel SW may comprise a rim SR providing a functional segment comprising a sensor for hands-off detection SN/HOD and/or a heating section or element SH/HT. As indicated schematically in FIG. 3D, steering wheel SW may comprise a switch ST for interaction with a vehicle system.

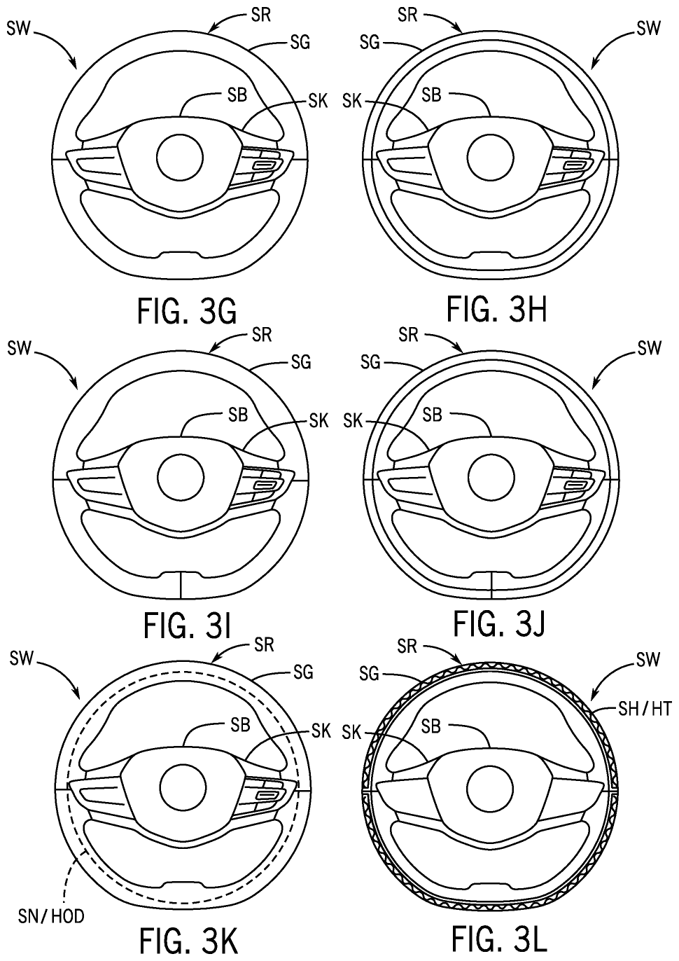

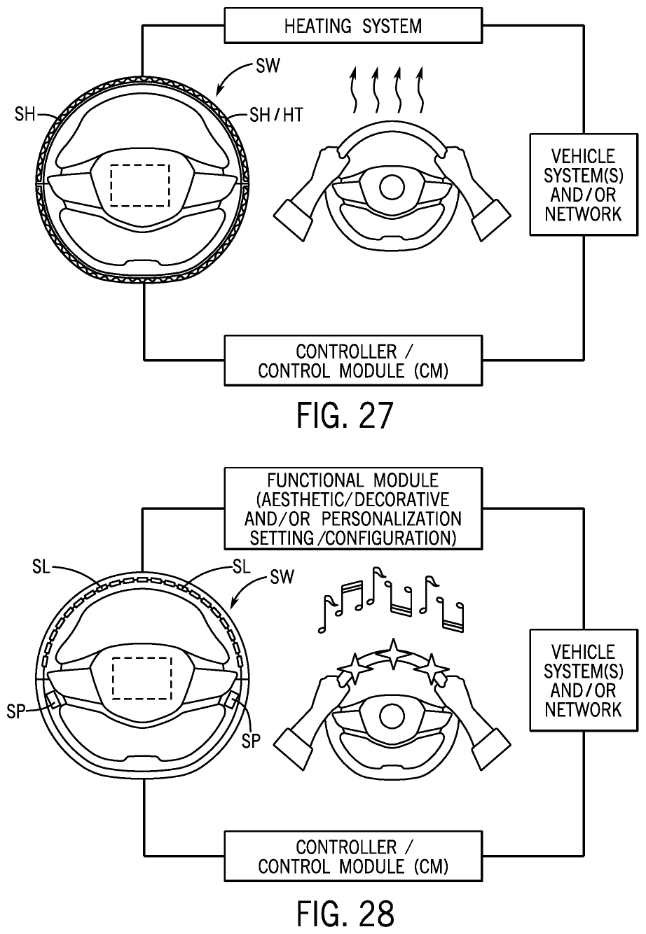

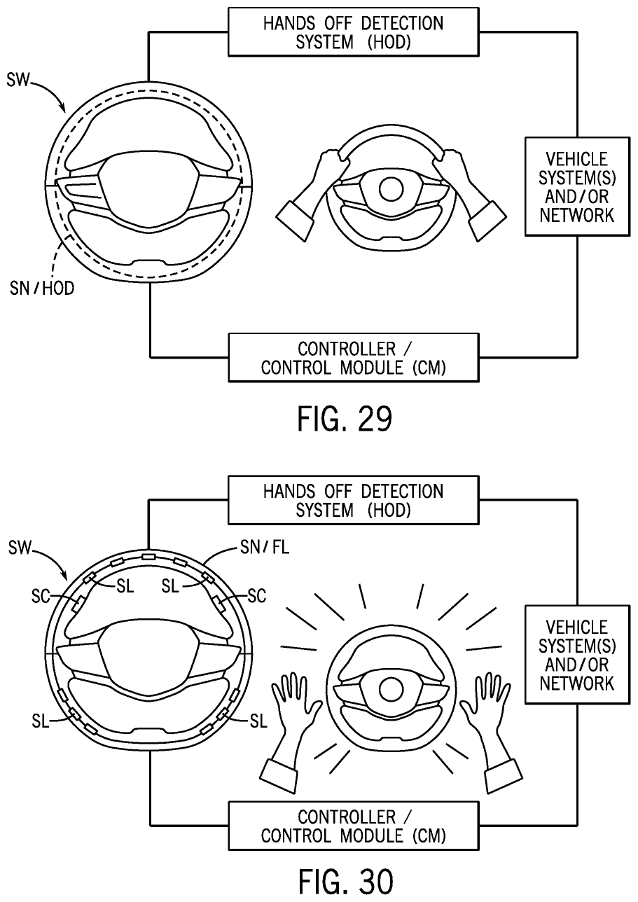

According to an exemplary embodiment as shown schematically in FIGS. 2C-2D, steering wheel SW may comprise a rim SR providing a functional segment comprising a functional module FM and/or a functional layer FL; functional segment may be configured to perform any of variety of functions as indicated schematically in FIGS. 4A-4I, 5A-5L, 26A-26B, 27, 28, 29, 30, 31, 32 and 33A-33B.

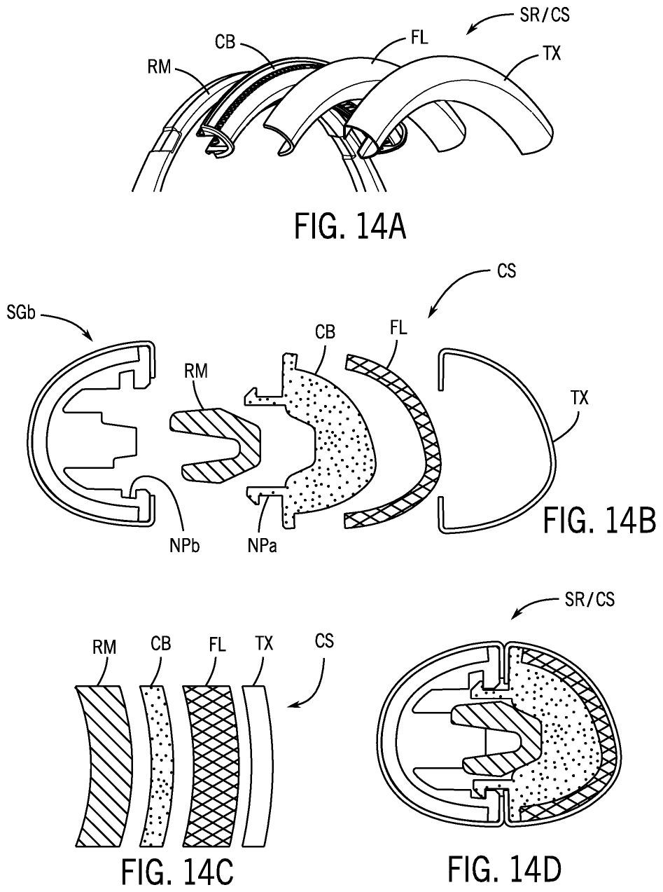

As indicated schematically in FIGS. 2C-2D, 4A-4I, 5A-5L, 17A-17B, 18A-18B, 26A-26B, 27, 28, 29, 30, 31, 32 and 33A-33B, steering wheel SW may comprise a controller/control module CM shown as installed within base SB; rim SB of steering wheel may be configured to provide a user interface UI for interaction between an occupant/operator of the vehicle with vehicle systems, network communications, etc. As indicated schematically in FIGS. 2C-2D, 4A-4I and 5A-5L, user interface UI may comprise at least one functional module FM configured to operate at the direction of the vehicle occupant and/or with a control program from a control module CM. See also FIGS. 17A-17B, 18A-18B, 26A-26B, 27, 28, 29, 30, 31, 32 and 33A-33B.

As indicated schematically in FIGS. 2C-2D, 4A-4I and 5A-5L, rim SR may comprise a functional segment that comprises a lighting module/system SL, a speaker SP, a transducer SC, etc.; rim SR may comprise multiple functional segments and/or combined functional segments such as an audio system (e.g. speaker and microphone), transducer SC configured to provide haptic feedback (e.g. vibration), sensor SN to detect contact/hands off-on by the vehicle operator, a display/light panel SD, etc. See also FIGS. 3K-3L, 17A-17B, 18A-18B, 26A-26B, 27, 28, 29, 30, 31, 32 and 33A-33B.

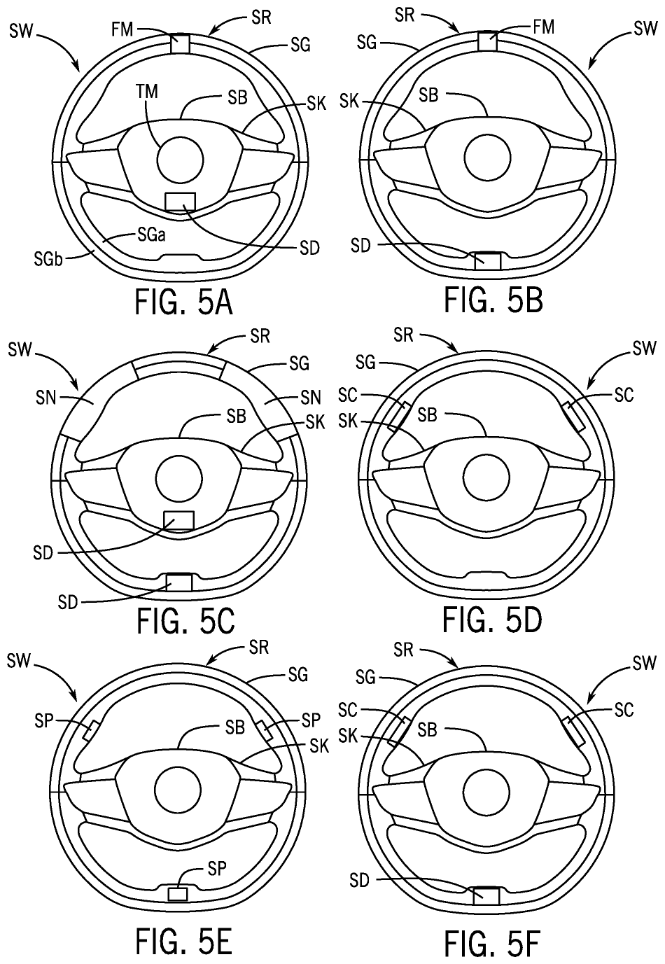

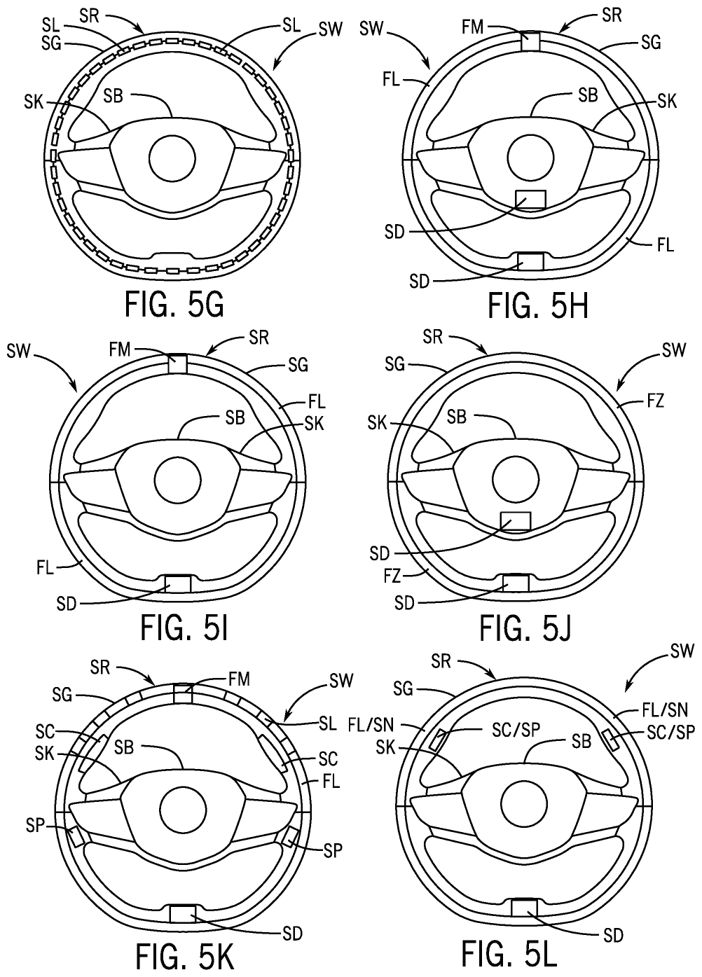

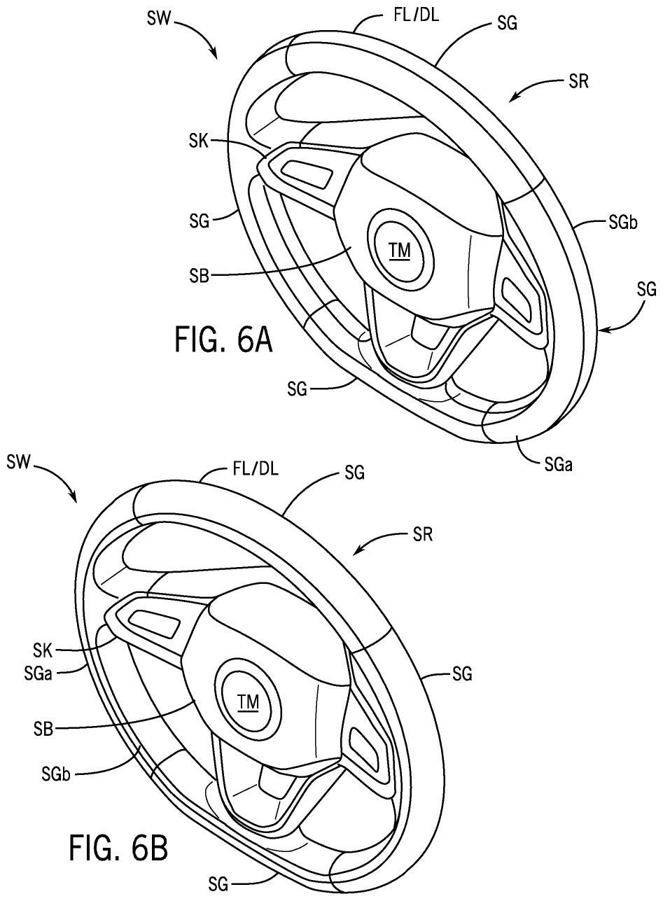

As indicated schematically according to an exemplary embodiment in FIGS. 6A-6B and 7 and 8A-8B, the base SB of the steering wheel SW may comprise a base cover SBa and a rear housing SBb with a frame SBc and frame SBc to be assembled onto a frame structure shown as armature RM; the composite structure CS of rim SR of the steering wheel on the frame structure shown as armature RM may comprise segments SG that may comprise segment sections shown a shell sections SGa and SGb with a carrier CB that may comprise sections CBa and CBb. See also FIG. 9A.

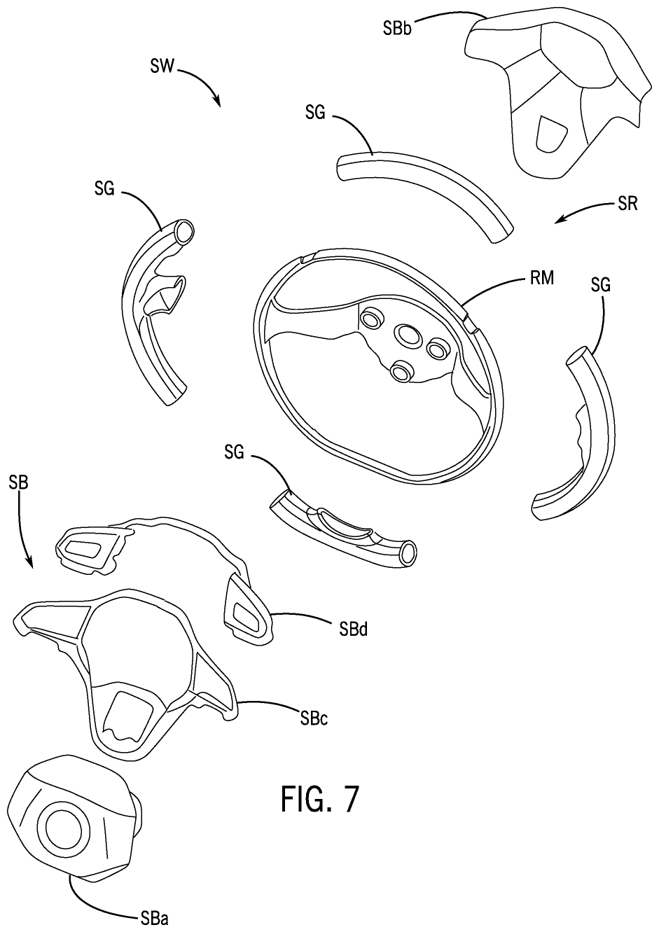

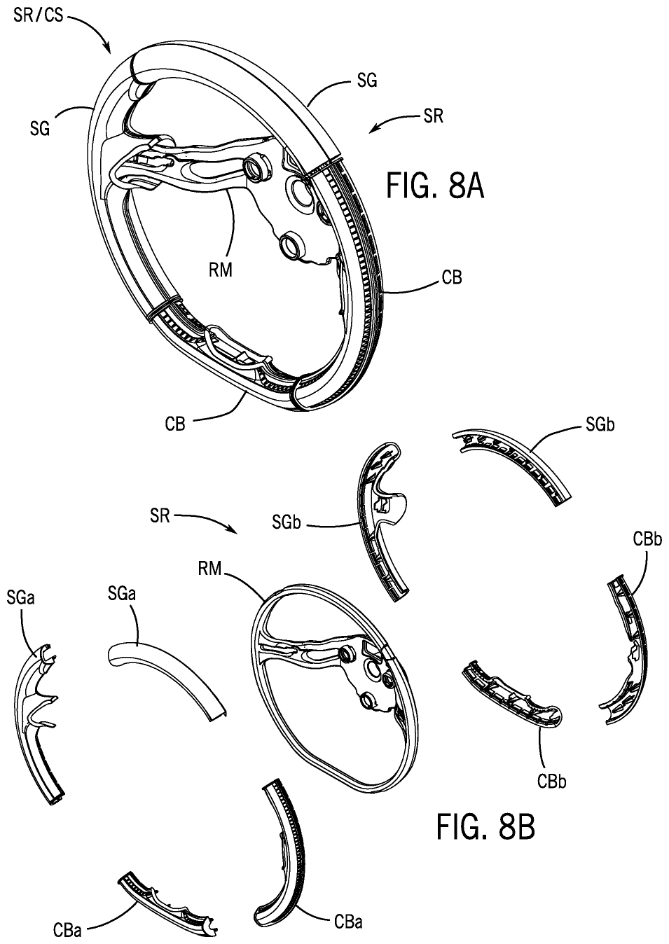

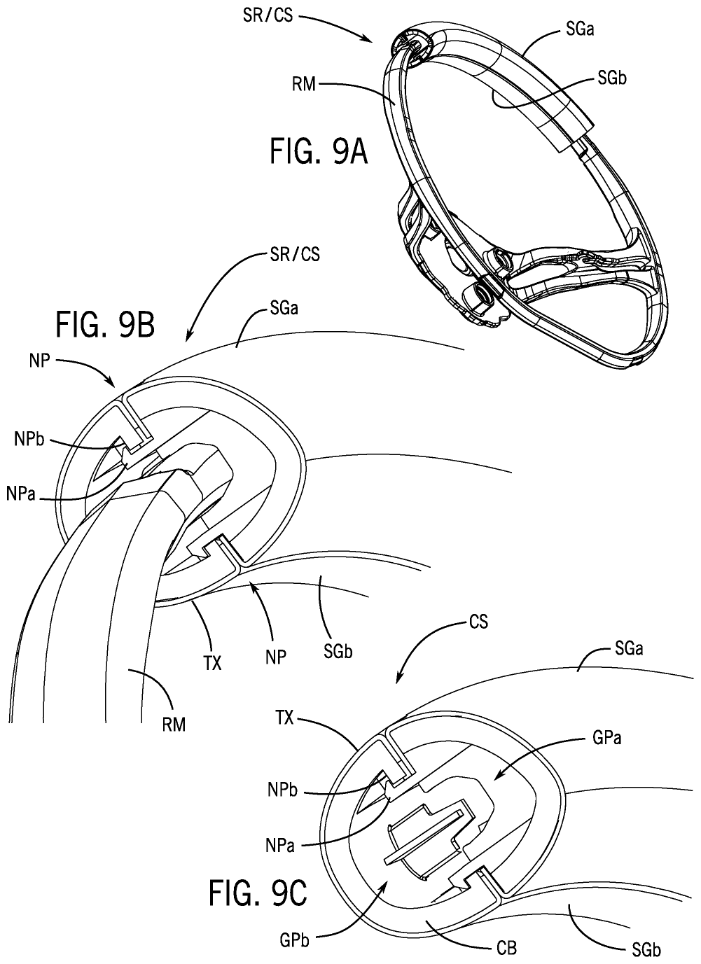

As indicated schematically according to an exemplary embodiment in FIGS. 9A-9C, 10A-10C, 11A-11D and 12A-12E, the composite structure CS for rim SR on frame RM may comprise segment SGa and segment SGb configured for engagement at an engagement portion NP shown as comprising engagement element NPa and engagement element NPb which engage to retain segment/sections SGa and SGb onto frame structure RM; segments SG may comprise a positioning/alignment section comprising element GPa and element GPb and a carrier/base layer CB with a cover comprising a cover layer TX. As indicated schematically in FIGS. 9B-9C, 10B-10C and 11D, engagement element NPa may be provided within the composite structure CS; as indicated schematically in FIGS. 12A-12B and 12D-12E, engagement element NPa may be provided on the frame structure RM. See also FIG. 12C (axially-oriented engagement element NPb).

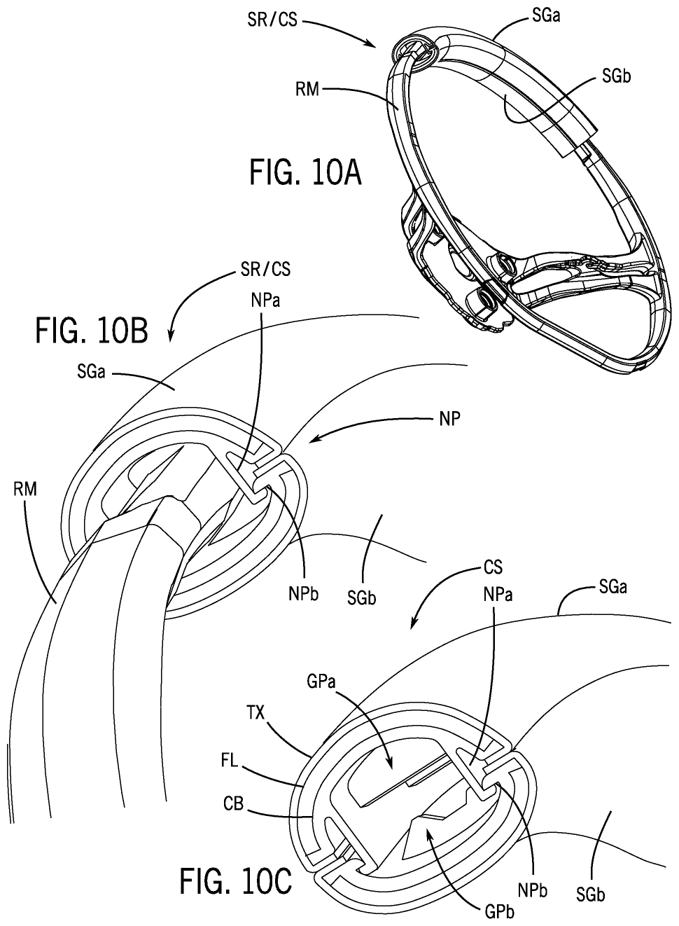

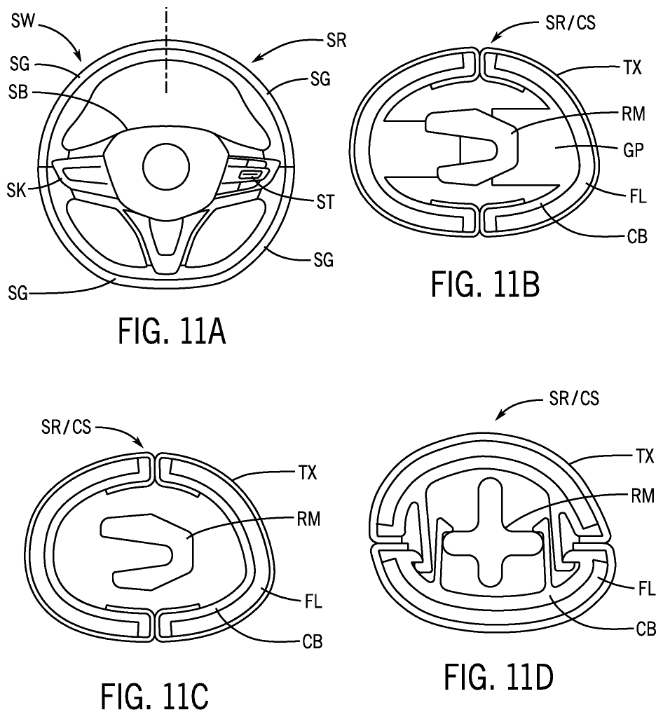

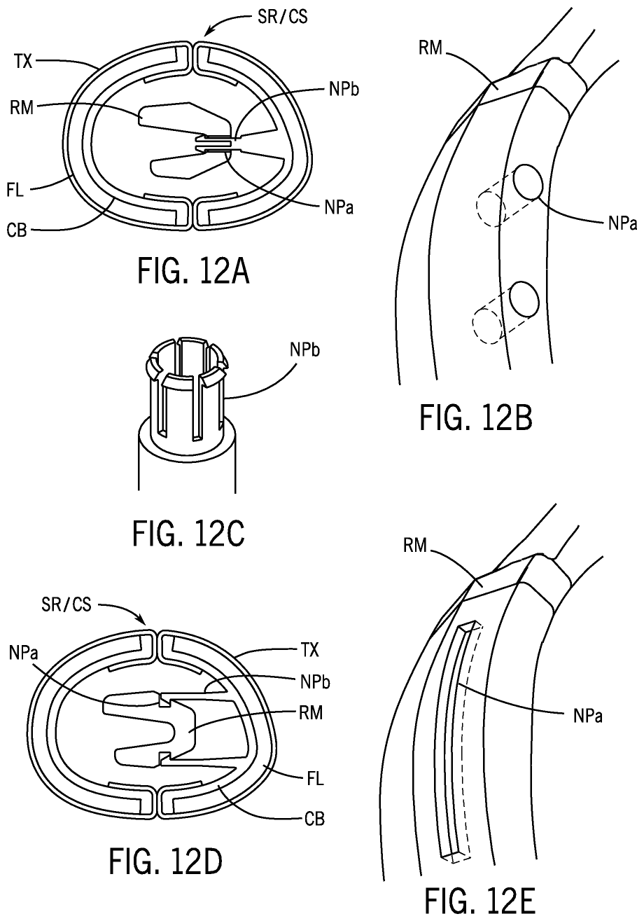

As indicated schematically according to an exemplary embodiment in FIGS. 13A-13D, 14A-14D and 15A-15D, the composite structure CS for rim SR on frame RM may comprise segment SGa and segment SGb configured for engagement at an engagement portion NP shown as comprising engagement element NPa and engagement element NPb which engage to retain segment/sections SGa and SGb onto frame structure RM; segments SG may also comprise a functional layer FL shown as a spacer material and a carrier/base layer CB with a cover comprising a cover layer TX. As indicated schematically, engagement element NPa and engagement element NPb may be provided within the composite structure CS (e.g. as a projection and retainer/recess for a fitting connection, such as a snap-fit connection).

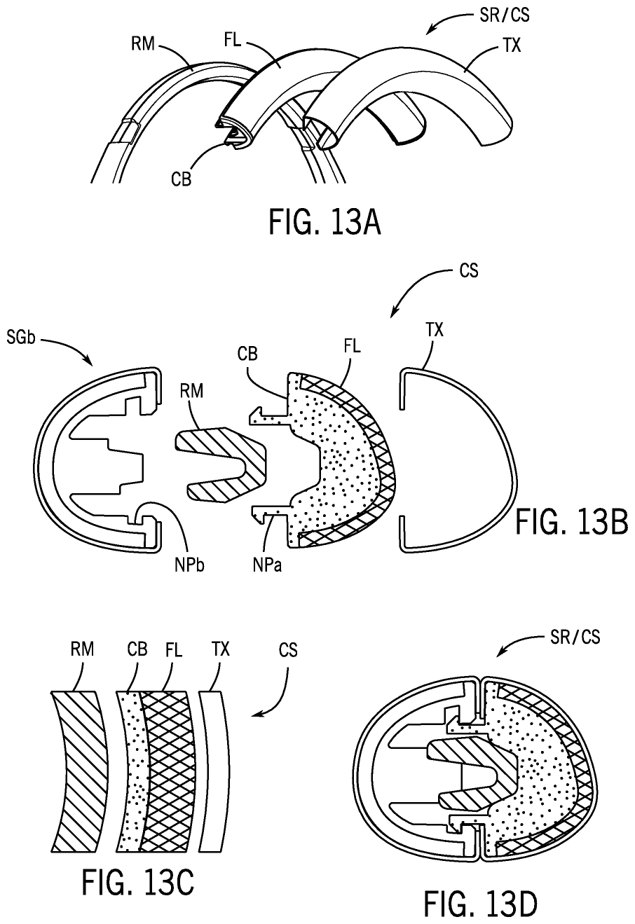

As indicated schematically according to an exemplary embodiment in FIGS. 16A-16F, the composite structure CS for rim SR on frame RM may comprise segment SGa and segment SGb configured for engagement at an engagement portion NP shown as comprising engagement element NPa and engagement element NPb which engage to retain segment/sections SGa and SGb onto frame structure RM; segments SG may comprise a positioning/alignment section comprising element GPa and element GPb (e.g. plurality of elements arranged for the segment/shell section) and a carrier/base layer CB with a cover comprising a cover layer TX. As indicated schematically, positioning element GPa and positioning element GPb may be provided within the composite structure CS to facilitate the placement/location of the segment/shell sections SGa and SGb during assembly onto frame structure RM; as indicated schematically, the positioning/alignment elements may provide structure for the segment and space/pathway for items such as connectors, wires, cables, lighting, sensors, etc. to be installed within the rim and/or between segments of the rim (e.g. such as for connectivity with functional segments, functional modules, functional layers, etc. to controller/control system, vehicle systems, etc.).

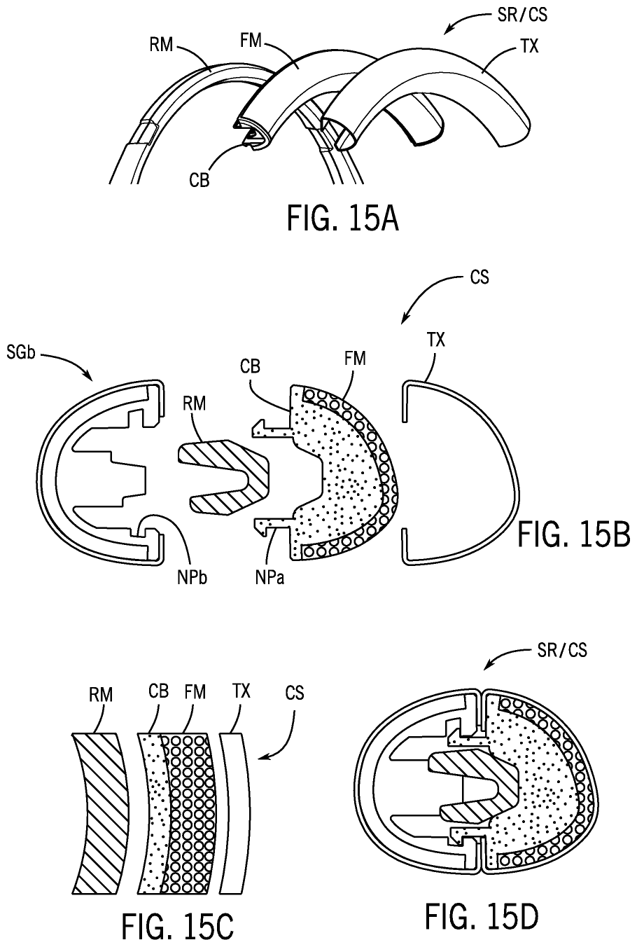

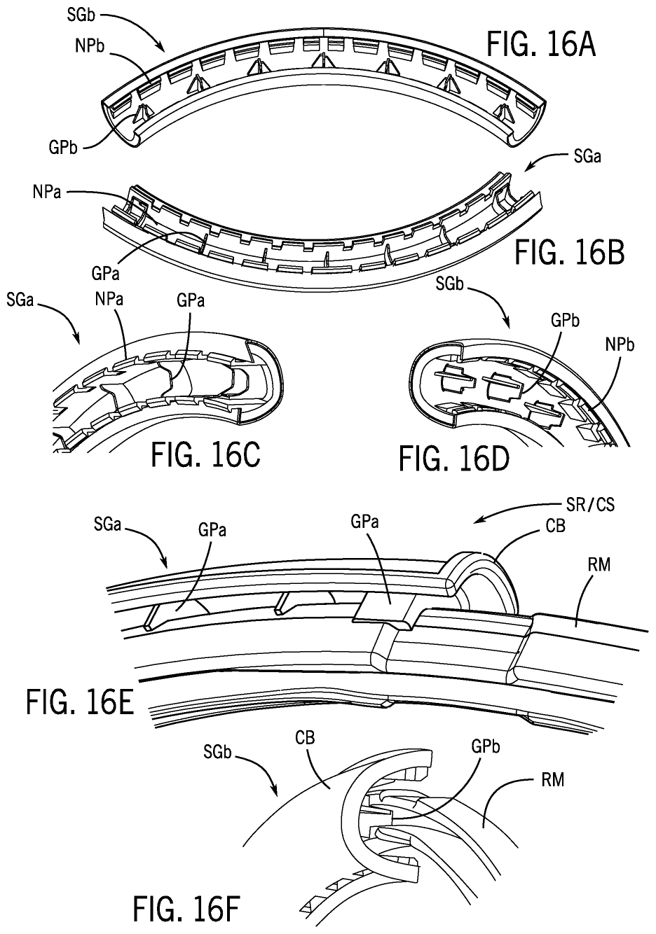

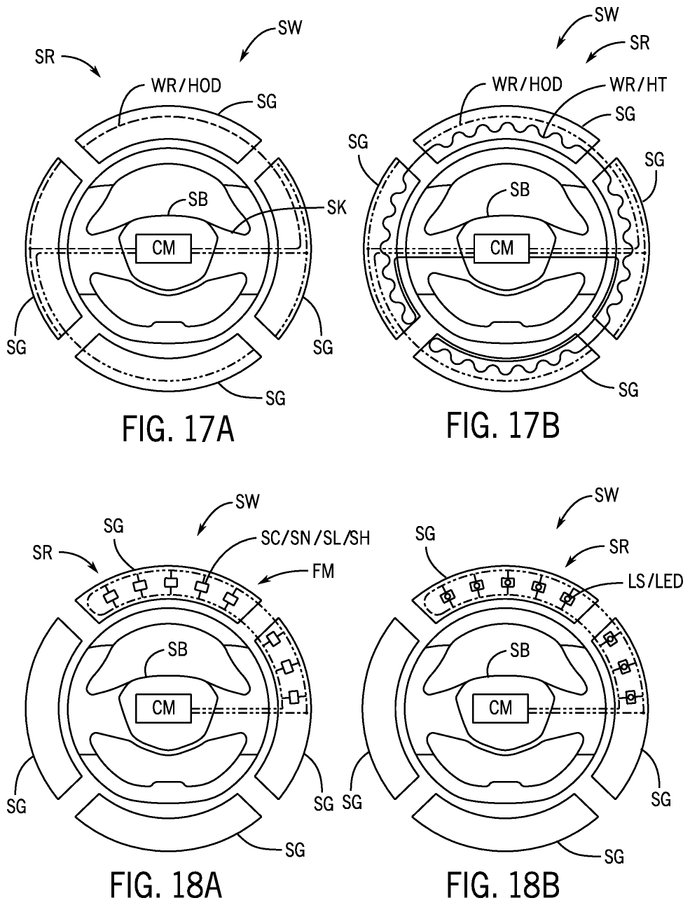

As indicated schematically in FIGS. 17A-17B, 18A-18B and 19A-19D, the steering wheel SW may comprise a controller/control module CM in the base SB with a rim SR comprising segments shown as functional segments SG (e.g. segments with functional layer/module) such as a hands-off sensor WR/HOD (see FIG. 17A) or an integrated arrangement of hands-off sensor WR/HOD with heating element WR/HT (see FIGS. 17B and 19A-19D) or a transducer SC or sensor SN or lighting elements SN or heating element/wire SH (see FIG. 18A) or lighting elements shown as light source/LED light LS/LED (see FIG. 18B). As indicated schematically in FIGS. 20A-20E, composite structure CS for segments of the rim such as functional segments comprising a carrier CB and functional layer FL comprising the integrated hands-off sensor HOD and heating element SH/HT (e.g. mat with heating wire arrangement) may be connected by a connector CN comprising a connector elements CNa and CNb and CNc and CNd positioned for electrical connectivity within the segment/rim.

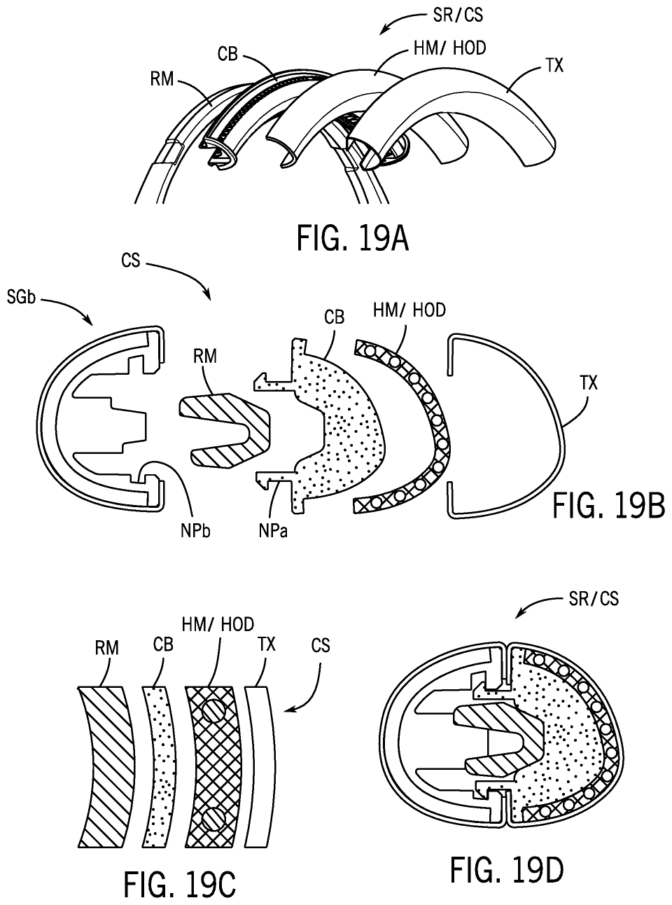

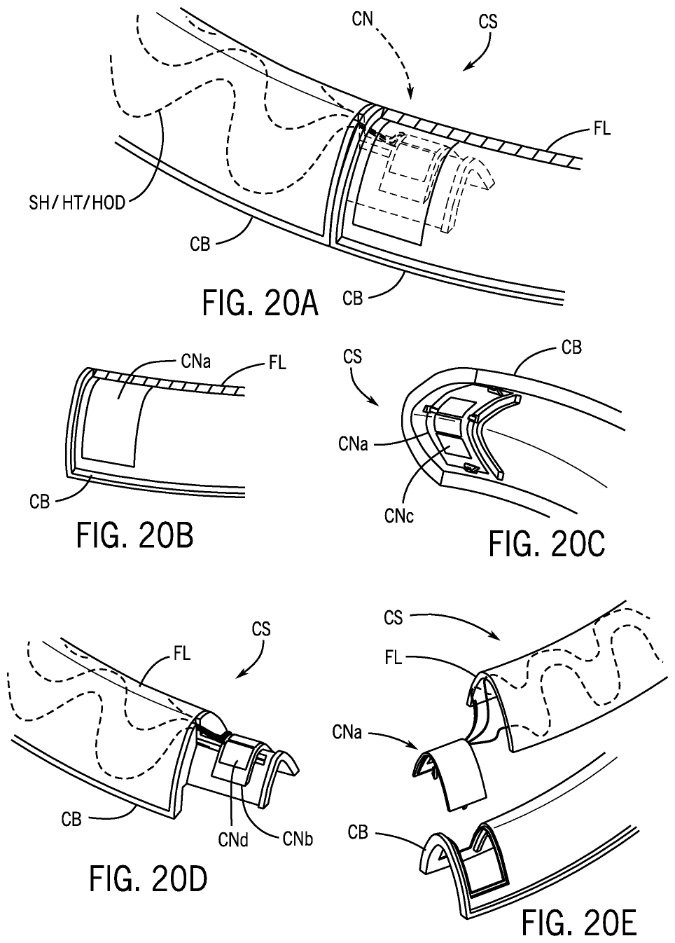

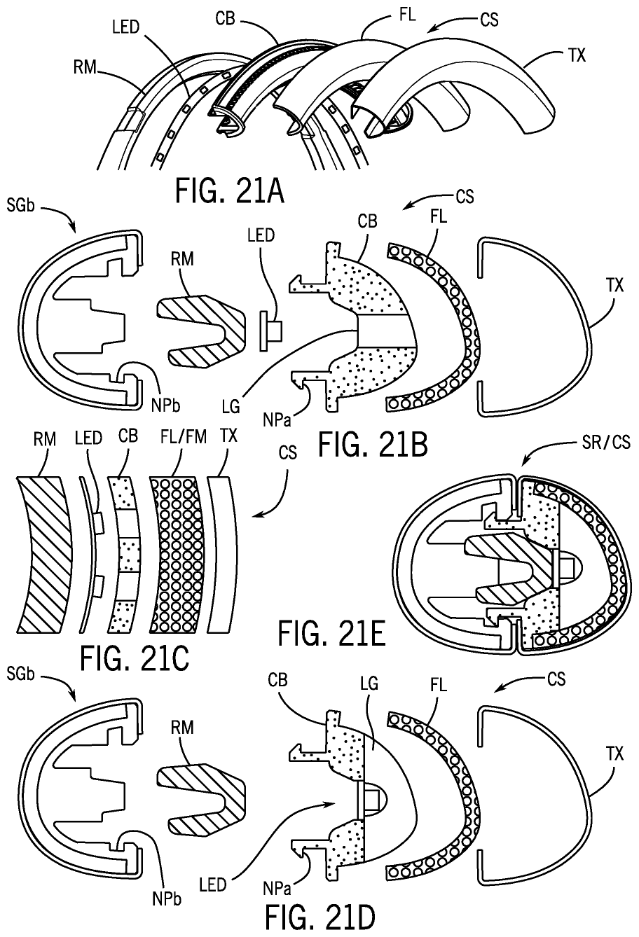

As indicated schematically according to an exemplary embodiment in FIGS. 21A-21D, 22A-22C and 23A-23C, the composite structure CS for rim SR on frame RM may comprise segment SGa and segment SGb configured for engagement at an engagement portion shown as comprising engagement element NPa and engagement element NPb which engage to retain segment/sections SGa and SGb onto frame structure RM; segments SG may comprise a functional/positioning module or layer FM/FL (shown as a foam/spacer material) and a carrier/base structure CB with a functional/lighting module LS/LP shown as an lighting arrangement comprising light guide LG (e.g. a light-transmissive element, lens, material, etc.) with LED arrangement (e.g. shown as comprising light elements LED) with a cover comprising a cover layer TX.

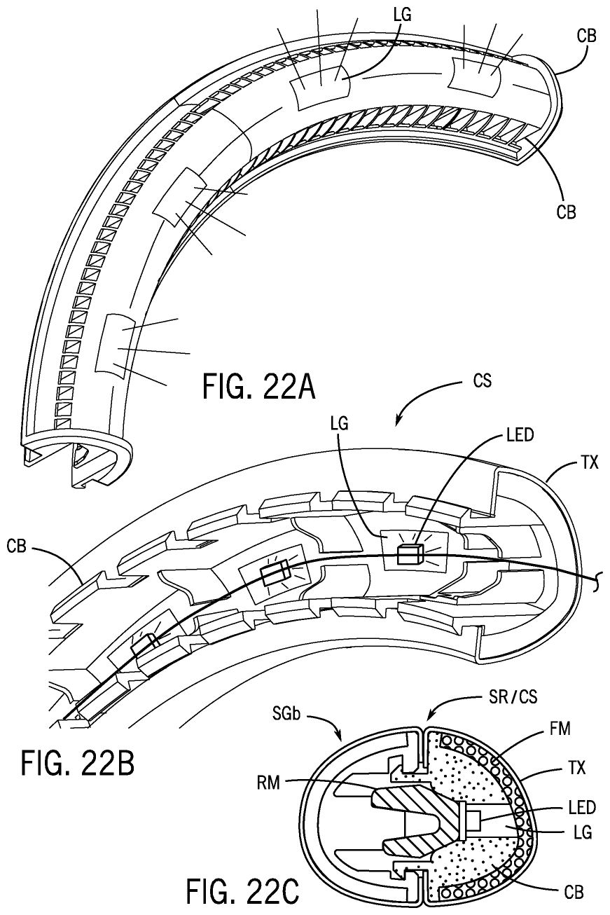

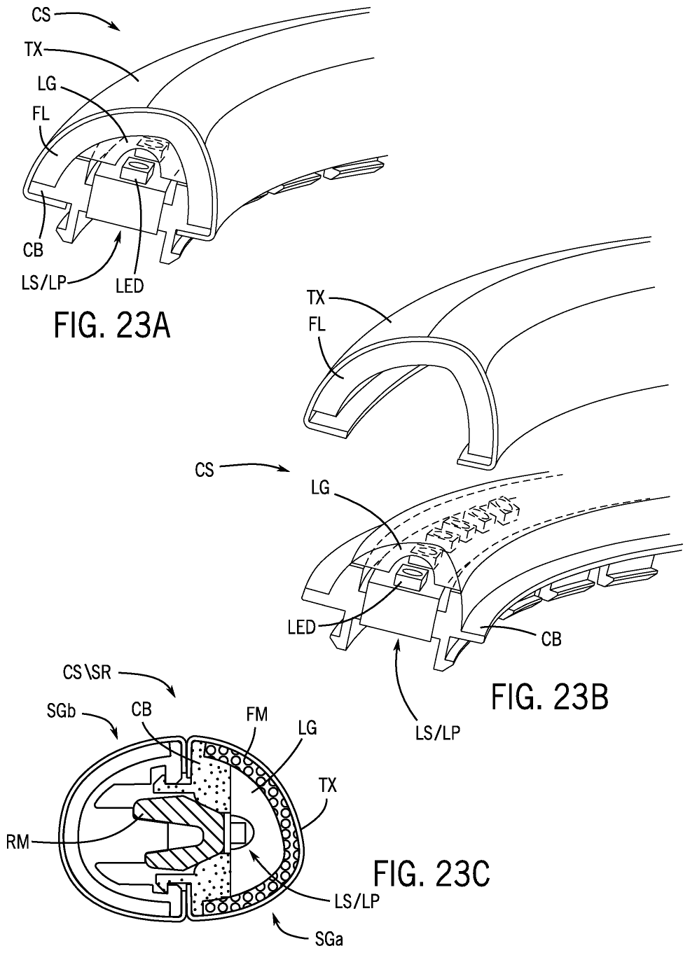

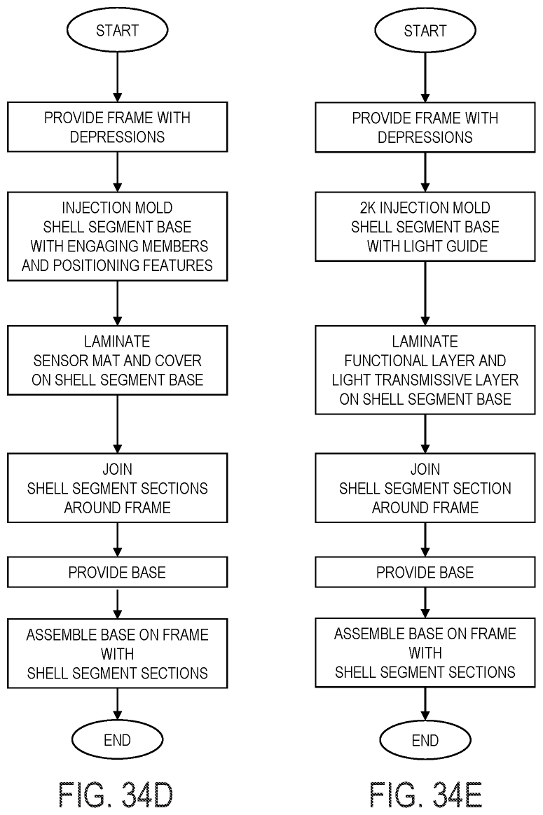

As indicated schematically in FIGS. 24A-24D and 25A-25E, an apparatus and method for forming the composite structure CSm comprising a barrier layer BL and functional layer FL shown as a spacer layer and a cover layer TX may be provided; the apparatus may comprise a mold tool with a forming tool MF and frame/clamp fixture MC and a base/bottom MB to form the shape of the composite structure CSm (see FIGS. 24A-24D); the apparatus may comprise a mold top MT with a slider MS to facilitate injection molding of resin R to form carrier CB for segment section SGb; to form the rim on the frame, segment section SGa may be assembled onto segment section SGb. See also FIGS. 34A-34E.

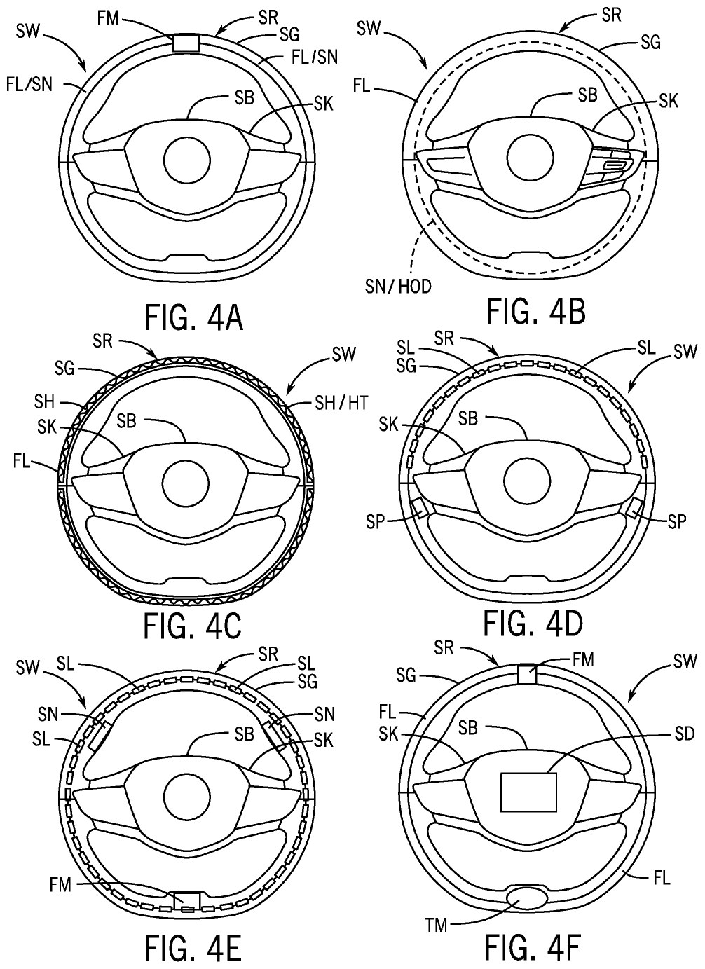

According to an exemplary embodiment as shown schematically in FIGS. 2A-2D, 26A-26B, 27, 28, 29, 30, 31, 32 and 33A-33B, the component shown as steering wheel SW with user interface UI provided through a functional module FM may be operated by a controller/control system CM in a vehicle comprising vehicle systems and/or connected to a network to perform any of a variety of functions for and with an occupant/operator of the vehicle. See also FIGS. 4A-4I and 5A-5L (configurations of steering wheel with composite structure/rim to provide user interface for input/output with vehicle occupant/operator).

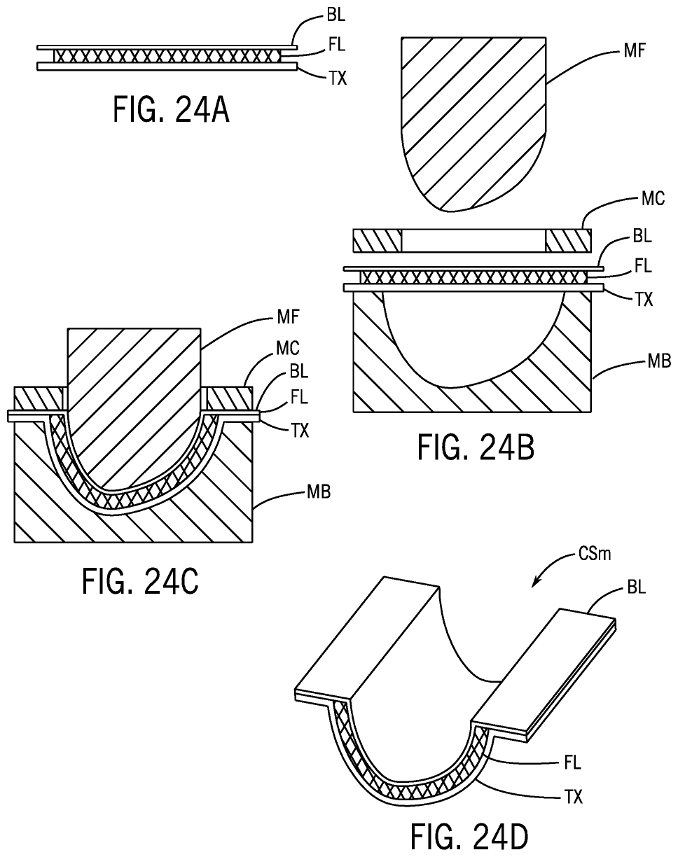

As indicated schematically in FIGS. 2C-2D and 26A-26B, the steering wheel SW with user interface UI may be provided with a functional module FM and/or functional layer FL such as a sensor SN that may be coupled to the controller/control system CM and vehicle systems/network (e.g. to perform any of a wide variety of functions such as communications, alerts, monitoring, sensing, detecting, comfort, etc.).

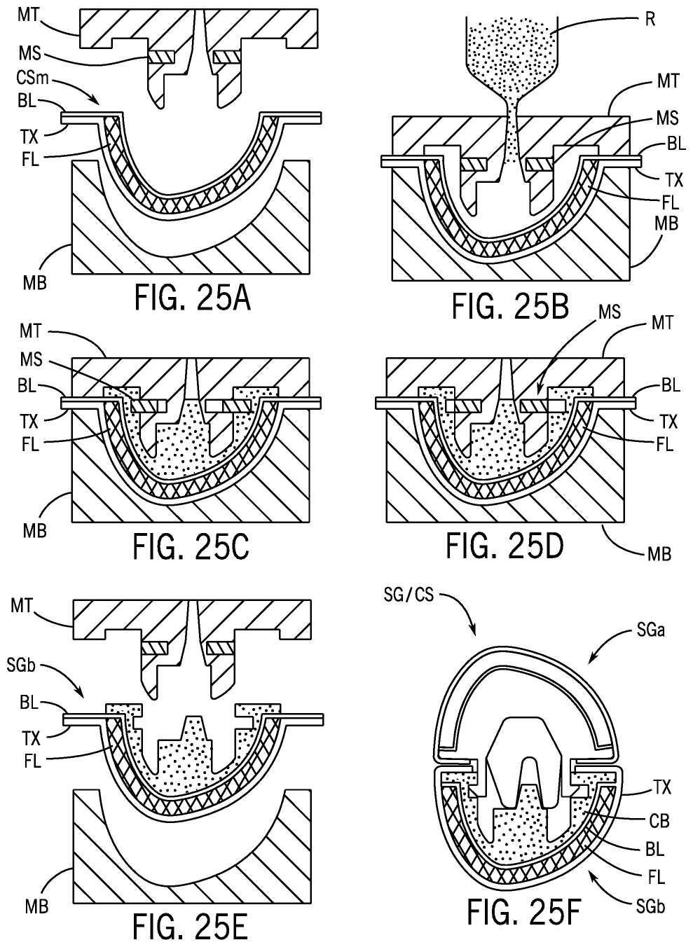

As indicated schematically in FIGS. 2C-2D and 27, the steering wheel SW with user interface UI may be provided with a functional module FM such as a heating system SH that may be coupled to the controller/control system CM and vehicle systems/network to be actuated/operated according to direction from the vehicle occupant to provide for comfort, etc.

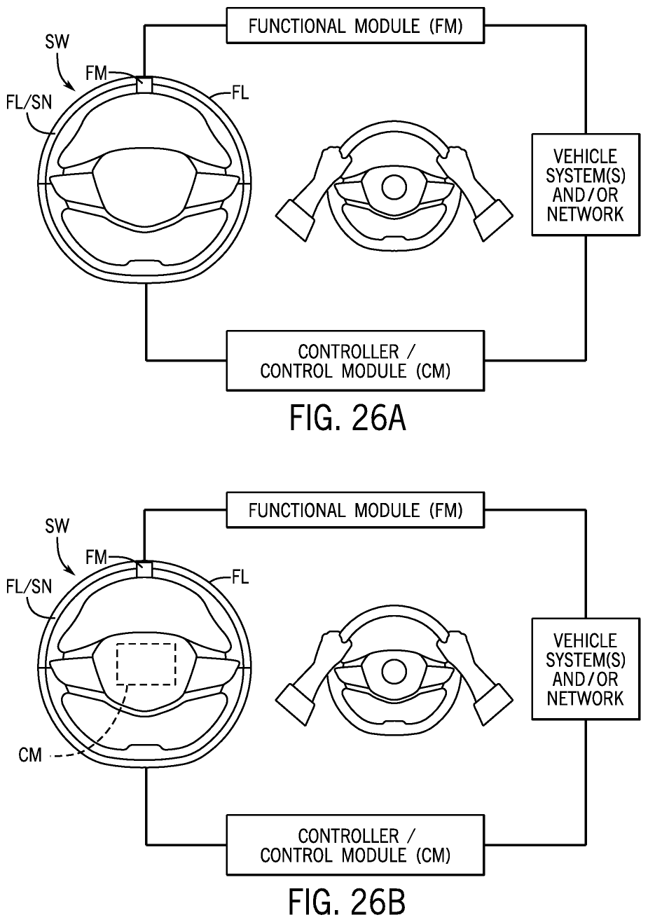

As indicated schematically in FIGS. 2C-2D and 28, the steering wheel SW with user interface UI may be provided with a functional module FM such as a lighting system SL and speaker system SP that may be coupled to the controller/control system CM and vehicle systems/network to be actuated/operated according to direction from the vehicle occupant to provide for aesthetic/decorative and/or personalization (e.g. according to stored/saved settings and/or mobile device commands, etc.).

As indicated schematically in FIGS. 2C-2D, 29 and 30, the steering wheel SW with user interface UI may be provided with a functional module FM shown as functional layer FL such as a hands-off detection system HOD with sensors SN that may be coupled to the controller/control system CM and vehicle systems/network to be actuated/operated according to contact/touch with the vehicle operator; as indicated, if the sensors SN for system HOD detects that the vehicle operator is not in contact with the steering wheel in accordance with criteria established by the control program/system, an alert may be provided by a lighting system SL and/or a transducer SC (e.g. haptic and/or audio transducer) in an effort to call for attention from the vehicle operator.

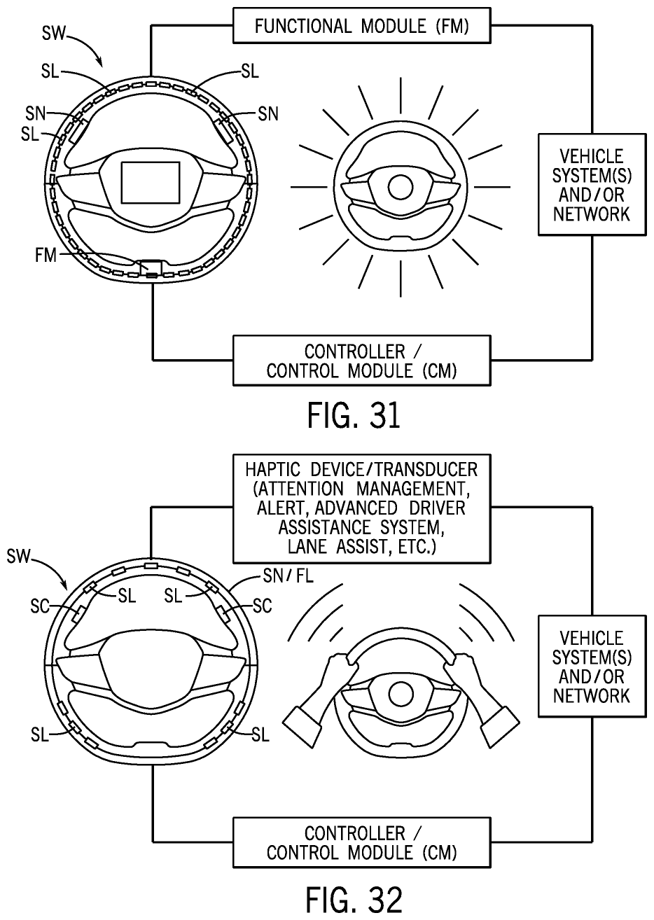

As indicated schematically in FIGS. 2C-2D and 31, the steering wheel SW with user interface UI may be provided with a functional module FM such as a lighting system SL and sensors SN (e.g. within a functional layer) that may be coupled to the controller/control system CM and vehicle systems/network to be actuated/operated according to direction from a control program/controller to provide communications/alerts to the vehicle occupant/operator (e.g. to provide indicators, signals, etc. according to stored/saved settings and/or mobile device commands, etc.).

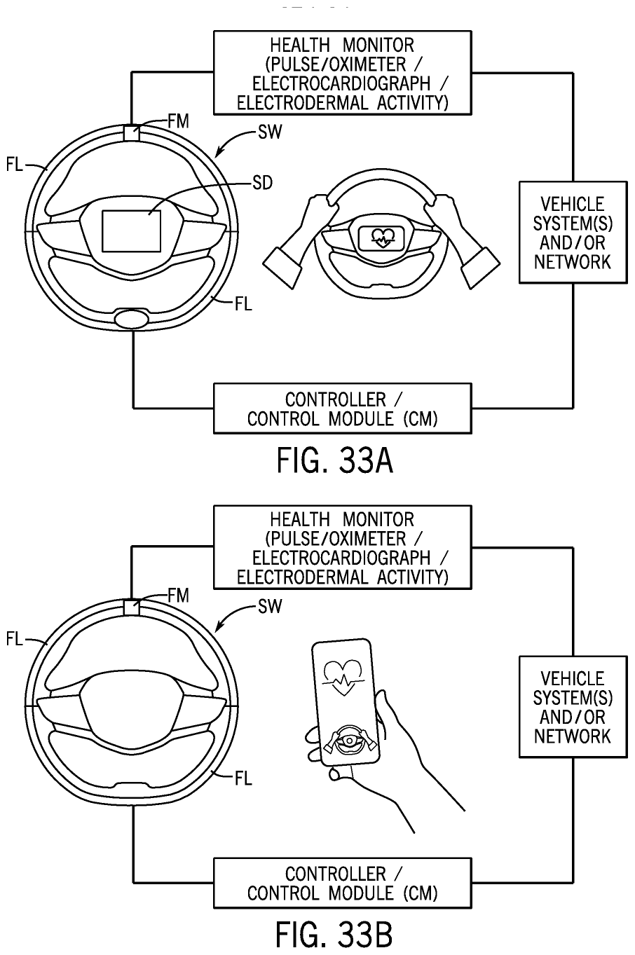

As indicated schematically in FIGS. 2C-2D and 32, the steering wheel SW with user interface UI may be provided with a functional module/layer FL such as a lighting system SL and transducer SC (e.g. device for haptic feedback/output) that may be coupled to the controller/control system CM and vehicle systems/network to be actuated/operated according to direction from a control program/controller to provide communications/alerts to the vehicle occupant/operator relating to attention management, advanced driver assistance system (ADAS), lane assist, etc. (e.g. to provide indicators, signals, etc. according to stored/saved settings and/or mobile device commands, etc.).

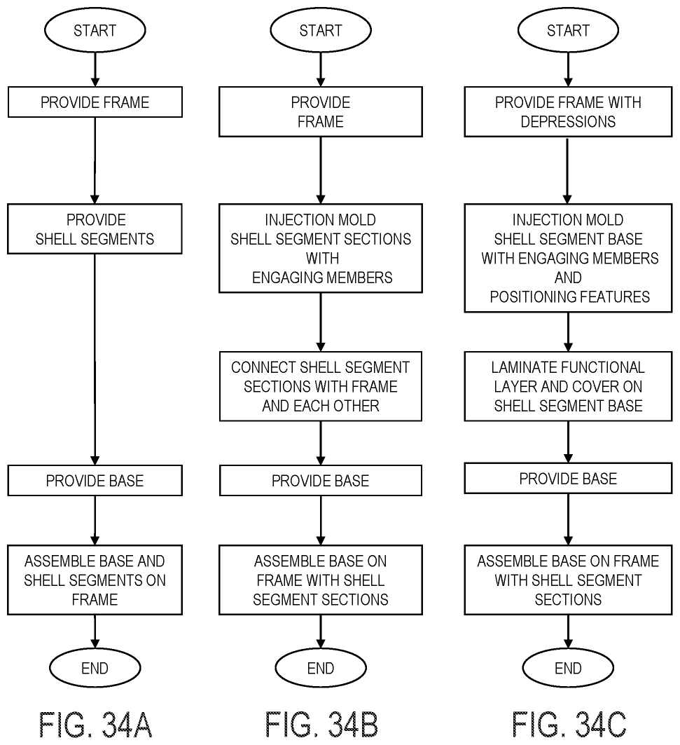

As indicated schematically in FIGS. 2C-2D, 4A and 33A-33B, the steering wheel SW with user interface UI may be provided with a functional module FM with functional layer FL comprising a sensor/sensor array SN configured to as a health monitor for the vehicle operator configured that may be coupled to the controller/control system CM and vehicle systems/network to be actuated/operated according to direction from a control program/controller to monitor such parameters as pulse rate, blood oxygen, cardiac activity, electrodermal activity, etc.) and to provide communications/alerts to the vehicle occupant/operator (e.g. to provide indicators, signals, etc. according to stored/saved settings and/or mobile device commands, etc.). As indicated schematically, data/information and communications/alerts may be presented at a display panel SD for the user interface on the steering wheel (see FIG. 33A) and/or at a component in the vehicle and/or at a data device/storage/computer or mobile device (see FIG. 33B).

### Exemplary Embodiments—A

As indicated schematically in FIGS. 2A-2D, 3A-3L, 4A-4I, 5A-5L, 6A-6B, 7 and 8A-8B, a component for an interior of a vehicle may comprise a rim configured to be assembled on a steering wheel comprising a frame; the rim may comprise a composite structure; the composite structure may comprise a set of segments to be assembled on the frame; the composite structure may comprise a cover and a carrier; a segment of the set of segments may comprise at least one of a decorative segment and/or a functional segment. The composite structure may comprise a positioning layer. The segment may comprise a manufactured segment and/or replaceable segment and/or an exchangeable segment and/or spare part segment. The segment may be configured to provide a cavity between the frame and the segment; the cavity may be configured to accommodate cables, wires, LEDs or electronic components. The segment of the composite structure may comprise a manufactured element and/or an exchangeable element and/or a replaceable element and/or a selectable element and/or a spare part segment. The segment may comprise a segment shell section configured to be attached by (a) by mechanical fastening and/or (b) by glue and/or (c) by ultrasonic welding; the segment shell section may be configured to be attached to an adjacent segment shell section by (a) by mechanical fastening and/or (b) by glue and/or (c) by ultrasonic welding. The component may be formed by a method of manufacturing comprising the steps of forming a base and a rim; providing a frame; providing a composite structure. The composite structure may be configured to provide a segmented cover; such that the steering wheel assembly comprises connecting the segmented covers and the frame. The connection may comprise at least one of clipping, latching, bonding, or welding.

According to an exemplary embodiment as shown schematically in FIGS. 2A-2D, 3A-3L, 4A-4I, 5A-5L, 6A-6B, 7 and 8A-8B, a component for an interior of a vehicle may comprise a steering wheel comprising a base and a rim. The rim may comprise a composite structure and a frame connected to the base. The composite structure of the rim may comprise at least one segment comprising a cover and an intermediate layer under the cover. The cover layer may comprise an exterior surface for the rim. The intermediate layer may comprise at least one of a soft material or a resilient material. The intermediate layer may comprise at least one of a foam material or a spacer material. The component may comprise a carrier on the frame. The carrier may comprise a carrier layer beneath the intermediate layer. The intermediate layer may comprise a carrier layer. The at least one segment may comprise at least one shell segment. The at least one segment may comprise an engagement portion. The at least one segment may comprise a set of segments. The set of segments may comprise a set of selectable segments configured to be assembled onto the frame of the rim. The rim may comprise a multi-segment construction comprising the set of segments. The rim may comprise a multi-segment construction comprising the set of selectable segments. The at least one segment may comprise a first segment and a second segment; the first segment may be axially connected to the second segment. The at least one segment may comprise a set of segments; the set of segments may comprise a first segment and a second segment; the cover layer on the first segment may be different than the cover layer on the second segment. The at least one segment may comprise a set of segments; the set of segments may comprise a first segment and a second segment; the first segment may be different than the second segment. The at least one segment may comprise a set of segments; each segment of the set of segments may comprise a segment base. Each segment of the set of segments may comprise an engagement portion. When the set of segments is assembled onto the frame the engagement portion of a first segment may be connected at the engagement portion of a second segment. When the set of segments is assembled onto the frame the engagement portion of a first segment may be clipped to the engagement portion of a second segment. When the set of segments is assembled onto the frame the engagement portion of a first segment may be connected at the engagement portion of a second segment in axial alignment. The engagement portion may comprise a connector and/or a plurality of connectors. The connector may comprise a clip connector. The connector may comprise a snap-fit connector. The engagement portion may comprise at least one of a projection and a receptacle for the projection. The connector may comprise a snap-fit connector comprising a projection and a receptacle for the projection. The at least one segment may comprise a set of shell segments. The set of shell segments may comprise a first shell section and a second shell section. When the set of shell segments is assembled onto the frame the first shell section may be attached to the second shell section. When the set of shell segments is assembled onto the frame the first shell section may be attached to the second shell section in radial alignment. The at least one shell segment may comprise a first shell section and a second shell section. The at least one shell segment may comprise a first shell section and a second shell section; the first shell section may be radially connected to the second shell section. The first shell section may comprise a first engagement portion; the second shell section may comprise a second engagement portion configured to engage the first engagement portion of the first shell section. The cover layer may comprise a decorative layer. The composite structure may comprise a positioning element. The at least one segment may comprise a positioning element. The cover may be configured to provide a visual effect for the rim. The cover may comprise a cover layer comprising at least one of a fabric material, a textile material, a fiber material, a leather, a synthetic leather material, a foil, a skin, a wrap, a vencer, a recycled material, an opaque material, a light-transmissive material. The cover layer may comprise a no-stitch appearance. The composite structure may be configured to provide a visual effect for the rim. The visual effect may comprise a multi-segment appearance. The visual effect may comprise a multi-section appearance. The visual effect may comprise a multi-tone appearance. The visual effect may comprise a no-stitch appearance. The visual effect may comprise a modular appearance. The at least one segment may comprise a first segment and a second segment; the cover of the first segment may be different from the cover of the second segment. The component may comprise a spoke structure connecting the rim to the base. The component may comprise a functional layer; the functional layer may comprise at least one of (a) a sensor for hands-off detection or (b) heating mat. The base may comprise an airbag module. The frame may comprise an armature. The base may comprise a cover; the cover may provide a logo. The composite structure may be configured for mass/weight reduction.

According to an exemplary embodiment as shown schematically in FIGS. 2A-2D, 3A-3L, 4A-4I, 5A-5L, 6A-6B, 7 and 8A-8B, a component for an interior of a vehicle may comprise a steering wheel comprising a base and a rim. The rim may comprise a composite structure and a frame connected to the base. The composite structure of the rim may comprise at least one segment comprising a cover and an intermediate layer under the cover. The composite structure may be configured to provide a visual effect for the rim. The at least one segment may comprise a set of segments. The visual effect may comprise a multi-segment appearance provided by the set of shell segments. The composite structure may be configured to provide a tactile effect. The set of segments may comprise a set of shell segments. The visual effect may comprise a multi-segment appearance. The visual effect may comprise a multi-section appearance. The visual effect may comprise a multi-tone appearance. The visual effect may comprise a no-stitch appearance. The cover may comprise a cover layer. The cover layer may be configured to provide the visual effect for the rim. The cover layer may comprise at least one of a fabric material, a textile material, a fiber material, a leather, a synthetic leather material, a foil, a skin, a wrap, a vencer, a recycled material, an opaque material, a light-transmissive material. The cover layer may comprise a no-stitch appearance. The intermediate layer may comprise at least one of a foam material or a spacer material. The intermediate layer may comprise a carrier layer on the frame. The at least one segment may comprise an engagement portion. The at least one segment may comprise a set of shell segments. The set of shell segments may comprise a set of selectable shell segments configured to be assembled onto the frame of the rim. The rim may comprise a multi-segment construction comprising the set of shell segments. The set of segments may comprise a first segment and a second segment; the cover on the first segment may be different than the cover on the second segment. The set of segments may comprise a first segment and a second segment; the first segment may be different than the second segment. The set of segments may be assembled onto the frame in axial alignment. The set of segments may be assembled onto the frame in axial alignment at an engagement portion. The engagement portion may comprise a connector for each segment of the set of segments. The connector may comprise a snap-fit connector comprising a projection and a receptacle for the projection. The at least one segment may comprise a first shell section and a second shell section. When the set of segments is assembled onto the frame the first shell section may be attached to the second shell section in radial alignment. The first shell section may comprise a first engagement portion; the second shell section may comprise a second engagement portion configured to engage the first engagement portion of the first shell section.

According to an exemplary embodiment as shown schematically in FIGS. 2A-2D, 3A-3L, 4A-4I, 5A-5L, 6A-6B, 7, 8A-8B, 17A-17B, 18A-18B, 26A-26B, 27, 28, 29, 30, 31, 32 and 33A-33B, a component for an interior of a vehicle may comprise a steering wheel comprising a base and a rim. The rim may comprise a composite structure and a frame connected to the base. The composite structure of the rim may comprise at least one segment comprising a cover layer and an intermediate layer under the cover layer. The composite structure may comprise a functional layer. The functional layer may comprise at least one of (a) sensor or (b) a transducer or (c) a light. The sensor may comprise at least one of (a) capacitive sensor or (b) an infrared sensor or (c) an ultrasonic sensor (d) conductive sensor or (c) light. The at least one segment may be configured for integration of the functional layer. The at least one segment may be configured for interconnection of the functional layer. The composite structure may comprise a connector for the functional layer. The base may comprise a control module for the functional layer. The composite structure may comprise a positioning element. The at least one segment may comprise a positioning element. The positioning element may be configured to facilitate connectivity for the functional layer. The positioning element may be configured to facilitate positioning of the cover layer relative to the frame. The base may comprise an airbag module. The frame may comprise an armature. The base may comprise a horn module.

According to an exemplary embodiment as shown schematically in FIGS. 2A-2D, 3A-3L, 4A-4I, 5A-5L, 6A-6B, 7, 8A-8B, 17A-17B, 18A-18B, 26A-26B, 27, 28, 29, 30, 31, 32 and 33A-33B, a component for an interior of a vehicle may comprise a steering wheel comprising a base and a rim. The rim may comprise a composite structure and a frame connected to the base. The composite structure of the rim may comprise at least one segment comprising a cover and an intermediate layer under the cover. The composite structure may comprise a functional layer. The functional layer may comprise at least one of (a) a sensor and/or (b) a transducer and/or (c) a hands-off sensor and/or (d) a heating element. The transducer may comprise at least one of (a) an audio speaker and/or (b) a microphone and/or (c) a haptic device. The functional layer may comprise a user interface. The cover may comprise a cover layer. The at least one segment may comprise at least one shell segment.

According to an exemplary embodiment as shown schematically in FIGS. 2A-2D, 3A-3L, 4A-4I, 5A-5L, 6A-6B, 7, 8A-8B, 17A-17B, 18A-18B, 26A-26B, 27, 28, 29, 30, 31, 32 and 33A-33B, a component for an interior of a vehicle configured to provide a user interface for a vehicle occupant in a vehicle comprising vehicle systems may comprise a steering wheel comprising a base and a rim. The rim may comprise a composite structure and a frame connected to the base. The composite structure of the rim may comprise at least one shell segment comprising a cover and an intermediate layer under the cover. The rim may comprise a functional module. The functional module may comprise at least one of (a) a sensor and/or (b) transducer and/or (c) a hands-off sensor and/or (d) a heating element and/or (c) a light and/or (f) a display. The functional module may comprise the display; the display may comprise a display panel. The light may comprise a light panel. The light may comprise an LED element. The light may comprise a set of LED elements. The transducer may comprise at least one of (a) an audio speaker and/or (b) a microphone and/or (c) a haptic device. The sensor may comprise a hand-off detector. The sensor may be configured to detect health-related information. Health-related information may comprise a signal representative of at least one of heart rate, blood oxygen saturation, sweat, temperature. The sensor may comprise an ECG (electrocardiograph) electrode to measure heart condition such as heart rate, heart rate variability. The sensor may comprise a PPG (photoplethysmography) optical sensor to measure blood oxygen saturation. The sensor may comprise an EDA sensor to measure skin potential, skin DC conductance, and skin AC admittance. The sensor may be configured to detect input from the vehicle occupant at or adjacent to the exterior surface of the cover. The sensor may be configured to represent a switch. The switch may be configured to operate a vehicle system. The user interface may be connected to at least one vehicle system. The user interface may be connected to a network. The user interface may be connected to a network using telecommunication protocols. The network may comprise the internet. The user interface may be configured to be connected to a device. The device may comprise a mobile device. The mobile device may comprise a telecommunication device connected to a network. The telecommunication device may comprise a smart phone. The functional module may comprise a functional layer for the composite structure. The functional layer may comprise at least one of (a) a sensor and/or (b) a transducer and/or (c) a hands-off sensor and/or (d) a heating element. The functional layer may be configured under the cover. The functional layer may comprise a light source and the cover may comprise a light-transmissive cover layer. The functional module may comprise a light source configured to transmit light through the cover. The functional module may comprise a functional layer. The functional layer may comprise a light guide configured to transmit light. The functional layer may comprise a light guide configured to transmit light through the cover. The functional layer may comprise a light guide configured to transmit light from a light source. The functional module may comprise a display configured to provide illumination at least partially visible at the cover. Operation of the user interface for the vehicle occupant may comprise at least one of (a) an output signal (b) an input signal. The output signal may comprise at least one of (a) light or (b) information display or (c) sound or (d) vibration or (c) haptic output. The input signal may comprise at least one of (a) touch or (b) sound or (c) a signal detected by a sensor. The at least one segment may comprise a set of segments on the frame; the set of segments may comprise a functional segment comprising a functional module. The at least one segment may comprise a set of shell sections; the set of shell sections may comprise a front section and a back section. The at least one segment may comprise a decorative segment. The cover may comprise a decorative layer. The at least one segment may comprise a functional segment. The functional segment may comprise a functional layer. The user interface may comprise an input device and an output device. The user interface may comprise connectivity with vehicle systems and/or a network. The component may comprise a controller for the user interface. The component may comprise a control system for the user interface. The user interface may comprise at least one of signaling, alerting, sensing, detecting, messaging, reporting. The user interface may comprise at least one of transmission of light, display of information, audio input, audio output, haptic feedback, health-sensing, heating, multi-functionality. The composite structure may comprise at least one of a light source, an LED, a LED arrangement, a display, a display panel. The user interface may be configured for at least one of connectivity to a vehicle system, connectivity to a network, connectivity to a mobile device, connectivity to a component, connectivity to a communication network, connectivity to the internet.

According to an exemplary embodiment as shown schematically in FIGS. 2A-2D, 3A-3L, 4A-4I, 5A-5L, 6A-6B, 7, 8A-8B, 17A-17B, 18A-18B, 26A-26B, 27, 28, 29, 30, 31, 32 and 33A-33B, a component for an interior of a vehicle may comprise a steering wheel comprising a base and a rim. The rim may comprise a composite structure. The composite structure may comprise a frame and a set of segments on the frame. The composite structure may comprise a cover and a positioning layer. Each segment of the set of segments may comprise at least one of a decorative segment and a functional segment. The functional segment may comprise a sensor. The functional segment may comprise a functional layer. The functional segment may comprise a functional module. The functional segment may be configured to provide a user interface for a vehicle occupant with vehicle systems and/or a telecommunication network. The cover may comprise an exterior surface. The functional segment may comprise the sensor. The functional segment may comprise a light display. The functional segment may comprise a functional layer. The composite structure may comprise a positioning layer. The cover may comprise a layer configured to facilitate the transmission of light. The sensor may be configured to detect input from the vehicle occupant at or adjacent to the exterior surface of the cover. The light display may be configured to provide illumination at least partially visible through the exterior surface of the cover. Operation of the user interface for a vehicle occupant may comprise at least one of output from illumination from the display and (b) input detected by the sensor. The composite structure may comprise (a) the cover; (b) the functional layer; (c) the sensor; (d) the positioning layer; (c) the display; (f) a substrate. The positioning layer may comprise at least one of (a) a foam material and/or (b) a spacer fabric. The cover may comprise at least one of (a) textile; (b) fabric; (c) fiber mesh; (d) leather; (e) grained surface; (f) synthetic fibers; (g) natural fibers; (h) artificial leather; (i) polyester; (j) fabric sheet; (k) upholstered material; (l) a fleece material; (m) a woven material; (n) a non-woven material; (o) a sheet material; (p) a perforated material; (q) a composite of multiple fiber materials; (r) a translucent material; (s) a resilient material; (t) a leather material configured to facilitate the transmission of light; (u) a material that is partially transparent and partially opaque; (v) a layer configured to facilitate transmission of visible light; (w) a surface material perforated to improve the visibility of light from the display. The cover may comprise a light-transmissive cover comprising at least one of (a) film; (b) resin; (c) polycarbonate; (d) polyurethane; (c) polyvinyl material; (f) TPO; (g) a polymeric material; (h) a polymeric film; (i) a composite of multiple plastic materials; (j) a composite of multiple materials; (k) a composite of fiber material; (l) natural material; (m) metal; (n) a perforated material; (o) a translucent layer. The functional layer may be configured for at least one of (a) positioning; (b) spacing; (c) haptic feedback; (d) tactile feedback such as vibration; (c) audible feedback such as sound; (f) optical enhancement; (g) light shielding; (h) interaction with a vehicle system; (i) cushioning; (j) tactile shear/feel performance; (k) heating; (l) cooling; (m) diffusion of illumination from the display; (n) alerting; (o) messaging; (p) light guiding; (q) flexibility. The positioning layer may be configured to retain positioning within the composite structure for operation of the sensor from input from the vehicle occupant; the positioning layer may comprise at least one of (a) a spacer; (b) a flexible spacer; (c) a spacer fabric; (d) a foam material; (c) a plastic material; (f) fabric; (g) polyurethane; (h) a woven material; (i) a spacer material; (j) a fabric material; (k) a fiber material. The user interface may be configured so that input from the vehicle occupant at the exterior surface of the cover is detected by the sensor. The user interface may be configured so that output from the display is presented at least partially through the exterior surface of the cover. The composite structure may comprise a substrate. The substrate may comprise a carrier. The component may comprise a control system configured to connect the user interface to at least one vehicle system; the control system may be configured to facilitate operation by the vehicle occupant of at least one vehicle system. The component may comprise a control system for the user interface configured for at least one of (1) visible feedback, (2) audible feedback, (3) tactile feedback, (4) haptic feedback to the vehicle occupant. The user interface may be configured for interaction with a vehicle occupant by at least one of (a) touch at the exterior surface of the cover detected by the sensor or (b) gesture adjacent to the exterior surface of the cover detected by the sensor. The sensor may comprise at least one of (a) an array; (b) a grid; (c) a foil; (d) a panel; (c) a touch panel; (f) a flexible panel; (g) a detector; (h) a proximity detector; (i) a capacitive touch panel; (j) a pressure sensitive panel. The user interface may comprise a light display; the light display may comprise at least one of (a) an array; (b) a panel; (c) a flexible panel. The composite structure may comprise a composite surface; the cover may comprise an at least partially translucent cover; illumination from the display at the exterior surface of the composite structure may comprise visible light transmitted through the functional layer and through the at least partially translucent cover. The sensor may be configured to detect input from the vehicle occupant at or adjacent to the exterior surface of the cover. The functional segment may comprise a functional layer configured for at least one of (a) positioning; (b) spacing; (c) haptic feedback; (d) tactile feedback such as vibration; (c) audible feedback such as sound; (f) optical enhancement; (g) light shielding; (h) interaction with a vehicle system; (i) cushioning; (j) tactile shear/feel performance; (k) heating; (l) cooling; (m) diffusion of illumination from the display; (n) alerting; (o) messaging; (p) light guiding; (q) flexibility. The sensor may be configured to detect input from the vehicle occupant at or adjacent to the exterior surface of the cover from at least one of (a) touch; (b) pressure; (c) proximity; (d) position. The positioning layer may comprise at least one of (a) a spacer; (b) a flexible spacer; (c) a spacer fabric; (d) a fabric material; (e) a foam material; (f) a plastic material; (g) a woven material; (h) a fiber material; (i) fabric; (j) polyurethane; (k) a spacer material. The cover may comprise at least one of (a) textile; (b) fabric; (c) fiber mesh; (d) leather; (e) grained surface; (f) synthetic fibers; (g) natural fibers; (h) artificial leather; (i) polyester; (j) fabric sheet; (k) upholstered material; (l) a fleece material; (m) a woven material; (n) a non-woven material; (o) a sheet material; (p) a perforated material; (q) a composite of multiple fiber materials; (r) a translucent material; (s) a resilient material; (t) a leather material configured to facilitate the transmission of light; (u) a material that is partially transparent and partially opaque; (v) a layer configured to facilitate transmission of visible light; (w) a surface material perforated to improve the visibility of light from the display; (x) film; (y) resin; (z) a composite of multiple materials; (aa) a composite of fiber material; (bb) natural material; (cc) metal; (dd) a perforated material; (ee) a translucent layer.

### Exemplary Embodiments—B

As indicated schematically in FIGS. 2A-2D, 3A-3L, 4A-4I, 5A-5L, 6A-6B, 7 and 8A-8B, the composite structure of the rim of the steering wheel may comprise segments such as shell segments configured to facilitate variable/various, customizable, light weight construction for decoration and that can be produced efficiently and/or connected and replaced and selected for arrangement; connection between segments may comprise mechanical connections such as clips, ribs, protrusions (and counterparts); connection of segments and the form of the composite structure can be configured to facilitate positioning and alignment as well as to enhance/control spacing/distance, ensure robust connection (e.g. reduce squeak, rattle, etc.) and to provide space for available to be used for electronic components (e.g, wires, LED, transducers, sensors, plug in connectivity, etc.) and/or other materials and items within the rim.

As indicated schematically in FIGS. 2A-2D, 3A-3L, 4A-4I, 5A-5L, 6A-6B, 7 and 8A-8B, the composite structure of the rim of the steering wheel may comprise segments such as shell segments provides a design configuration that facilitates interchangeable variations of segments and/or decorative/cover materials with visual effect, tactile effect, durability, functional capability; internal construction configuration facilitates integration of different individual or multiple functions as well as a lower mass/lighter weight form that is intended to be more efficient to produce (e.g. no stitching, no-stitch appearance, reduced size/mass, simpler mechanical connections, fewer total parts, etc.); the configuration of the composite structure and/or segments are intended to facilitate replacement and/or updating over the vehicle life time (e.g. including available interchange/exchange such as using new parts, spare parts for update/replacement, etc.).

As indicated schematically in FIGS. 2A-2D, 3A-3L, 4A-4I, 5A-5L, 6A-6B, 7, 8A-8B, 17A-17B, 18A-18B, 26A-26B, 27, 28, 29, 30, 31, 32 and 33A-33B, the composite structure of the rim of the steering wheel may comprise segments such as shell segments configured as segmented sections with fitting parts that integrate functional modules providing features (e.g. sensing, heating, hands off detection, lighting, health monitoring/sensing (heart rate by ECG, skin, conductance by EDA and oxygen saturation in the blood by oximeter or by PPG); integration of a functional module/layer in the composite structure of the rim facilitates efficient assembly and construction to allow the overall intended decorative effect and tactile effect/durability (e.g. material selection for appearance, visual effect, tactile effect, durability, customization, sustainability, light weight, etc.). Construction of the composite structure is intended to facilitate integration of layers and elements including functional, positioning/alignment, decorative, etc. intent as well as selective positioning of functional elements (e.g. lighting, heating, sensing/detecting, button/switches, input/output for user interface) and or decorative effects for enhanced performance and manufacturability; fitment of elements of the composite structure and/or connection of segments/sections can be enhanced to facilitate use of space within the rim for optimized performance (e.g. space creation, air gap, light weight, package space for electronic functions.

According to an exemplary embodiment, a vehicle interior component and a method for manufacturing said vehicle interior component is shown schematically in the FIGURES; the component may comprise a trim component comprising a cover and a substrate/carrier in a composite structure assembled on a frame for the rim of a steering wheel. The cover may comprise an exterior cover layer, an intermediate cover layer, a functional layer and a base. The substrate may comprise a depression, a projection and/or a fastening portion. The substrate may comprise a metal and a soft material. The cover/base may comprise a depression, a projection and/or a fastening portion. The depression and/or projection are configured to align substrate and cover. The cover may comprise cover segments. The cover segments may be configured to present the cover. The functional layer may comprise a heating mat, a sensor, a light-transmissive layer. The method of forming/assembling the component may comprise (a) at least one of a foaming process, an injection molding process or a press lamination process; (b) positioning of the cover or of the cover segments on the substrate; (c) fixing of the cover or of the cover segments to the substrate; (d) surrounding of the substrate with cover segments; (e) joining of the cover segments with each other around the substrate.

The vehicle interior component may be configured to present a user interface at a steering wheel. The method and component are configured to provide an effective method of steering wheel trim, a customizable steering wheel cover, and an effective method of replacing the steering wheel cover.

According to an exemplary embodiment, the rim and composite structure may comprise selected materials for cost/performance; the frame structure/armature may comprise a metal, metal alloy (e.g. magnesium, aluminum, steel, etc.); the shell segments and other plastic elements such as the carrier, etc. may comprise a plastic, molded plastic (e.g. polypropylene, nylon plastic, polyamide nylon, polystyrene, acetal plastic, polyoxymethylene, polycarbonate, acrylonitrile butadiene styrene, polyethylene terephthalate, or other plastic compounds); the heating mat and/or sensor layer may comprise a commercially-available structure or an integrated/formed structure with heating wires (e.g. within a matrix/substrate, foam, elastomer, filled foam, graphene-filled foam, etc.); connections and connectors for electric/electronic system may be commercially-available structures or produced from suitable materials (e.g. as for heating mat/wires, sensor mat, etc.).

According to an exemplary embodiment as indicated schematically in FIGS. 2A-2D, 3A-3L, 4A-4I, 5A-5L, 6A-6B, 7 and 8A-8B, a component for an interior of a vehicle may comprise a rim configured to be assembled on a steering wheel comprising a frame; the rim may comprise a composite structure; the composite structure may comprise a set of segments to be assembled on the frame; the composite structure may comprise a cover and a carrier; a segment of the set of segments may comprise at least one of a decorative segment and/or a functional segment. The composite structure may comprise a positioning layer. The segment may comprise a manufactured segment and/or replaceable segment and/or an exchangeable segment and/or spare part segment. The segment may be configured to provide a cavity between the frame and the segment; the cavity may be configured to accommodate cables, wires, LEDs or electronic components. The segment of the composite structure may comprise a manufactured element and/or an exchangeable element and/or a replaceable element and/or a selectable element and/or a spare part segment. The segment may comprise a segment shell section configured to be attached by (a) by mechanical fastening and/or (b) by glue and/or (c) by ultrasonic welding; the segment shell section may be configured to be attached to an adjacent segment shell section by (a) by mechanical fastening and/or (b) by glue and/or (c) by ultrasonic welding. The component may be formed by a method of manufacturing comprising the steps of forming a base and a rim; providing a frame; providing a composite structure. The composite structure may be configured to provide a segmented cover; such that the steering wheel assembly comprises connecting the segmented covers and the frame. The connection may comprise at least one of clipping, latching, bonding, or welding.

REFERENCE SYMBOL LIST

| ELEMENT, PART | REFERENCE |
|---|---|
| OR COMPONENT | SYMBOL |
| Vehicle | V |
| Interior | I |
| Door Panel | DP |
| Floor Console | FC |
| Instrument Panel | IP |
| Steering Wheel | SW |
| User Interface | UI |
| Composite Structure | CS, CSm |
| Armature/Frame | RM |
| Base | SB, SBa, SBb, SBc, SBd |
| Spoke | SK |
| Rim | SR |
| Switch | ST |
| Controller/Control Module | CM |
| Functional Module | FM |
| Connector | CN, CNa, CNb, CNc, CNd |
| Wire | WR |
| Shell Segment/Section | SG, SGa, SGb |
| Logo/Emblem | TM |
| Shell Segment Base | CB |
| Positioning Means | GP, GPa, GPb |
| Light Guide | LG |
| Engagement Member | NP, NPa, NPb |
| (Fastening Member) | |
| Light Panel/Display | LP |
| Light Source | LS |
| Transducer (Haptic/ | SC |
| Microphone/Speaker) | |
| Display | SD |
| Heater | SH |
| Light | SL |
| Sensor | SN |
| Audio Module/Speaker/Microphone | SP |
| Functional Layer | FL |
| Hands-Off Detection/Sensor | HOD |
| Heating Mat | HT |
| Decorative Layer | DL |
| Cover | TX |
| Barrier Layer/Structure | BL |
| Resin | R |
| Tool/Mold | M |
| Tool Bottom Section | MB |
| Clamping Frame | MC |
| Forming Tool | MF |
| Slider | MS |
| Tool Top Section | MT |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A component for a vehicle interior comprising a steering wheel comprising:
a frame;
a composite structure configured to be assembled on the frame;
wherein the composite structure comprises a cover and a carrier;
wherein the composite structure comprises a set of segments;
wherein a segment of the set of segments comprises at least one of a decorative segment and/or a functional segment.

2. The component of claim 1 wherein the composite structure comprises a rim; wherein the rim comprises the set of segments comprising the decorative segment and the functional segment; wherein the rim comprises a modular design.

3. The component of claim 1 wherein the functional segment is configured to provide a user interface; wherein operation of the user interface comprises at least one of signaling, alerting, sensing, detecting, messaging, reporting.

4. The component of claim 3 wherein operation of the user interface comprises an output signal and/or an input signal.

5. The component of claim 4 wherein the output signal comprises at least one of (a) light or (b) information display or (c) sound or (d) vibration or (e) haptic output.

6. The component of claim 4 wherein the input signal comprises at least one of (a) touch or (b) sound or (c) a signal detected by a sensor.

7. The component of claim 4 further comprising a control system configured to facilitate operation of at least one vehicle system through the user interface.

8. The component of claim 1 wherein the functional segment comprises a sensor; wherein the sensor is configured to detect input from a vehicle occupant at or adjacent to the exterior surface of the cover from at least one of (a) touch; (b) pressure; (c) proximity; (d) position; (e) a switch.

9. The component of claim 1 wherein the functional segment comprises a functional layer configured for at least one of (a) positioning; (b) spacing; (c) haptic feedback; (d) tactile feedback such as vibration; (e) audible feedback such as sound; (f) optical enhancement; (g) light shielding; (h) interaction with a vehicle system; (i) cushioning; (j) tactile shear/feel performance; (k) heating; (l) cooling; (m) diffusion of illumination from a display; (n) alerting; (o) messaging; (p) light guiding; (q) flexibility.

10. The component of claim 1 wherein the segment comprises at least one of (a) a sensor and/or (b) a transducer and/or (c) a hands-off detector and/or (d) a heating element and/or (e) a haptic device.

11. The component of claim 1 wherein the set of segments comprises a set of shell segments configured to be assembled on the frame.

12. The component of claim 1 wherein the functional segment comprises a positioning layer comprising at least one of (a) a spacer; (b) a flexible spacer; (c) a spacer fabric; (d) a fabric material; (e) a foam material; (f) a plastic material; (g) a woven material; (h) a fiber material; (i) fabric; (j) polyurethane; (k) a spacer material.

13. A component for a vehicle interior comprising a steering wheel configured to be attached to a base comprising:
a frame configured to be connected to the base;
a composite structure configured to be connected to the frame;
wherein the composite structure comprises at least one segment comprising a cover;
wherein the composite structure comprises a functional segment;
wherein the functional segment comprises a sensor and/or a transducer.

14. The component of claim 13 wherein the sensor comprises a hands-off sensor.

15. The component of claim 13 wherein the functional segment comprises a heating element.

16. The component of claim 13 wherein the transducer comprises at least one of (a) an audio speaker and/or (b) a microphone and/or (c) a haptic device.

17. The component of claim 13 wherein the functional segment comprises a user interface; wherein the user interface comprises an input device and an output device.

18. The component of claim 17 wherein operation of the user interface comprises at least one of transmission of light, display of information, audio input, audio output, haptic feedback, health-sensing, heating, multi-functionality.

19. The component of claim 13 wherein the functional segment comprises a functional module.

20. The component of claim 13 wherein the sensor is configured to detect input from a vehicle occupant at or adjacent to an exterior surface of the cover.

21. The component of claim 13 wherein the set of segments comprises a set of shell segments configured to be assembled in axial alignment on the frame; wherein the set of shell segments comprises a set of shell sections configured to be assembled in radial engagement around the frame.
